(19) United States
(12) Patent Application Publication
(10) Pub. No.: US 2017/0169387 A1
(43) Pub. Date: Jun. 15, 2017

(54) Wordless Express System and Method Thereof

(71) Applicant: Jianlin DAI, Maanshan City (CN)

(72) Inventor: Jianlin DAI, Maanshan City (CN)

(21) Appl. No.: 15/113,809

(22) PCT Filed: Jan. 23, 2015
(86) PCT No.: PCT/CN2015/071418

§ 371 Date: Oct. 16, 2016

(30) Foreign Application Priority Data
Jan. 24, 2014 (CN) 201410036845.6
Mar. 24, 2014 (CN) 201410111333.1

(51) Int. Cl. G06Q 10/08

(52) U.S. Cl. CPC G06Q 10/087

(57) ABSTRACT

A wordless express delivery system includes at least one wordless document file, which is securely affixed to an express delivery item corresponding to the wordless document file, so as to form a wordless express delivery item; and a wordless information management platform which manages the wordless document file, wherein the wordless information management platform acquires wordless information regarding to the wordless express delivery item in the wordless document file, so as to o obtain the delivery status of the wordless express delivery item, wherein there is no word marking and information of the wordless document file regarding to the express delivery item on the wordless document file, so as to eliminate the risk of disclosing the information regarding the express delivery.

### CROSS REFERENCE OF RELATED APPLICATION

This is a U.S. National Stage under 35 U.S.C. 371 of the International Application Number PCT/CN2015/071418, filed Jan. 23, 2015, which claims priority under 35 U.S.C. 119(a-d) to Chinese application number 201410111333.1, filed Mar. 24, 2014.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to computer system and method, and more particularly to a wordless express delivery system, wherein the wordless express delivery system forms a wordless express delivery item through a wordless document file, such that the text information recorded in the wordless document file will not be displayed to the public on the surface, so as to protect the relative information of the express delivery item during the logistics and delivery process and delivery and reduce the risks of disclosing the information of the express delivery item. However, the wordless document file is easy to be identified by the wordless express delivery system, so as to increase the efficiency of the express delivery.

Description of Related Arts

Express delivery is a type of the logistics. As the rapid development of electronic commerce, express delivery is playing a more and more important role in the whole logistics because of its point-to-point, rapid and convenience features.

In express delivery, the express delivery document such as waybill or receipt is the most significant element, which carries all information of the express delivery item, including the name of the express service supplier, the names, residence cities, destinations, addresses, contact numbers of the sender, and receiver, the dates of sending and receiving, the name of the courtier, description of contents, quantity/weight of contents, item number, express number, barcode of the express delivery item and etc.

However, the text information as listed above is all hand written on the pre-printed papery express waybill.

Also, the above text information has to be inputted and recorded into the system.

The express waybill recorded with the text information is pasted on the express delivery item and experienced the whole express delivery process with the express delivery item. Each express waybill is assigned with an unique express number. Therefore, the cost of the printing of the express waybill will increase accordingly due to the requirement of the uniqueness of each express waybill. The unique express number is associated the text information recorded on the express waybill with respect to the express delivery item, and thus the express service supplier can pass the status of express delivery item during the express delivery process on the platform of the system for the sender and receiver of the express delivery item to check, inquire and know the status of the express delivery item through the express number thereof. Although the information and the express number of the express waybill are recorded into a system of express service supplier, it is worth to mention that the recording of such information and express number into the system is manually by hand too. Since the express waybill is written manually, the recording courier has to go through an identification procedure and a recordation procedure. Due to the fact that the main information was hand written by the sender, if it is in poor handwriting, the identification process of the recording courier is adversely influenced and the recording time of recording courier is increased too. It is a small problem in reducing working efficiency, but it is a really big problem in causing erroneous judgement and sending the express delivery item to a false destination. In addition, during the sorting of express delivery items, the express courier delivers the express delivery item according to the information on the express waybill. If there is any damage to the express waybill or it is unable to identify the information recorded on the express waybill during the express delivery process, it may cause delay of the delivery time and even result in unable to delivery. If the express number on the express waybill is unable to be identified, it will result in failing to inquire the status of the express delivery item. There are two ways for inquiry of the status of the express delivery item. One way is making a phone call to the express service supplier to inquire by identifying the express number. However, inquiry via phone call consumes much energy in calling and waiting for both parties. Also, it is quite often that the phone can not get through. The other way is to login the web site of express service supplier and input the express number for inquiry. In other words, the express number itself is unable to directly provide the information of the status of the express delivery item. Before using the express number for inquiry, it is required to phone call the express service supplier or login the web site of the express service supplier even though there is an express number.

Nowadays, the importance private information protection has been increasingly emphasized. But not everyone notices that the private information on the express waybill is so complete and easy to be disclosed. As the receiver has received the express delivery item and removed the item out, the express waybill, which recorded the personal information of sender and receiver, sending and receiving destinations, dates of sending and receiving, content information, and so on, is usually be discarded. The relative information on the express waybill is disclosed easily and unconsciously through such discarded express waybill. There are names, contact numbers, addresses of sender and receiver on the express waybill. There is further more information regarding the express delivery item on the express waybill, such as printed matter, fragile products and so on. Also there is general value, even detail information of the content, such as desk lamp, mobile phone, regarding the express delivery item. To the express delivery industry, such information can help the service supplier to provide better service. But as the express service is completed, the express service supplier fails to initiatively offer any solution in how to deal with the information recorded on express waybill so as to prevent such recorded information from being leaked or disclosed, but simply let the sender or the receiver to handle it by themselves. Generally, the sender or the receiver will discard it directly. To the sender and receiver, all the information on the express waybill is known information. In other words, the information on the express waybill is worthless to the sender or receiver, and for worthless things, the most general way to deal with it is to abandon and discard. However, the sender and receiver may not realize that such known, accustomed, worthless express waybills substantially carry their personal and private information. Especially when several express delivery items are received, the most convenient way is to discard these express waybills. Since the traditional express service suppliers do not aware the problems of the leaking of personal and private information, they will not consider the solution of the problem caused by the disclosure of the personal and private information of the express waybills.

Besides the discarding of the express waybill, personal and private information may still be disclosed during the process of sorting and delivering of the express delivery item. As the information on the express waybill is disclosed to the public during the express delivery, the information on the express waybill is easily acquired by anyone who can be in contact with the express delivery item as well as the express waybill, or even the lost express waybill, resulting in disclosing and leaking of the information on the express waybill. In fact, since the sender has filled in the express waybill, the express delivery route to the express service supplier is decided. In other words, it is decided that the number of transmit stations and the order of the transmit stations. Accordingly, as the last transmit station has known the information of sender and/or receiver, the express delivery item can be sent to the sender and/or receiver. And each transmit station in the middle may simply require to know the next and the last transmit station of the express delivery item, that can reduce the disclosing the information on the express waybill by minimizing the disclosure of the information of the express waybill in the intermediate express delivery route.

Currently, information on the express waybill is directly published in words for ease of sorting and sending the express delivery item by the courier. But the information in words is the easiest way to be acquired. Even a quick glance on the express waybill may cause disclosure of the information. However, there is no other way to replace the text information written on the express waybill. The traditional express delivery system doesn't have the function of information disclosure prevention. Also, the traditional express delivery system has no consideration of the situation of the disclosure of the delivery information. Thus, the traditional express delivery system is not capable of protecting the information of clients efficiently.

As the express waybill on the express delivery item is in form of duplicate copies, filled in by hand-writing, wherein the first copy is relatively clearer than the other copies since it is directly written by hand. But after multiple transportation and rolling over, especially while the information is in illegible hand-writing, the writing may not be still clear to read after it is received by the receiver. Except the first copy, the other copies are printed by means of the carbonless copy. Due to the magnitude of the handwriting, the information on the other copies is always not being shown completely, that seriously affects the identification thereof.

As the courier visits the sender to collect the express delivery item, the sender can merely identify the identification of the courier by his or her uniform. Since the courier's identity is unable to be confirmed, the security of the express delivery item can not be assured too. On the other hand, the express service supplier also doesn't have a device to produce an express waybill that can distinguish express delivery item while protecting personal and private information thereof. There is no device that can identify the express waybill quickly too.

In addition, while the courier delivering the express delivery item, the courier usually and simply delivers the express delivery item to the destination without checking the receiver's information. There is always a risk that the express delivery item is fraudulently received and damaged. Also, during the delivery of an express delivery item by the courier, the final destination of the express delivery item is the destination printed on the express waybill which is non-amendable, either by the sender or the receiver, during the delivery process. If the receiver does not present at the destination printed on the express waybill, the corresponding express delivery item must still be delivered to the destination printed on the express waybill first. Then, the new destination of the receiver is required to be written in a new express waybill for delivery. In other words, the express delivery item is treated as a new express delivery item for delivery again. This is a waste of time to the receiver as well as a waste of resource of the express service supplier. If the information of destination and/or the receiver can be amended and changed during the express delivering process, it can save the time of the receiver as well as the resource of the express service supplier, so that improves the efficiency of express delivery service. Unfortunately, there is no such express delivery system currently.

According to the conventional express delivery system, the transport hub is a key hub. Therefore, the selection of the locations of the transport hubs is really important. However, as the development of the society, the mere location selection of the transport hubs cannot meet the development of the society because the location of the transport hub is fixed. Therefore, the means to enhance efficiency is limited to increase labors, routes planning, and etc. It will cost to much to relocate the transport hub. If the transport hub is mobile, the location selection problem of the transport hub can be solved. In addition, the traditional transport hub is generally designed in large-scale and centralized for having large covering area, wherein much more land resources are demanded, and it is especially not practical in the cities. On the other side, if the mobile transport hubs are built at those vacant lands existed in the cities, it can optimize the express delivery efficiency by alternating the locations of transport hub and improve the land utilization. Furthermore, if auto-driving transportation devices can be employed to transport the express delivery items between the transport hubs, the express delivery efficiency can thus be greatly increase while saving much cost. Unfortunately, there is no such express delivery system.

### SUMMARY OF THE PRESENT INVENTION

The invention is advantageous in that it provides a wordless express delivery system, wherein the wordless express delivery system provides a wordless document file which has no text and words used for identifying the information regard as the express delivery item being shown on the wordless document file, so as to reduce the risk of disclosing the information of the express delivery item.

Another advantage of the invention is to provide a wordless express delivery system, wherein the wordless document file produced by the wordless express delivery system can be securely provided on the express delivery item to form a wordless express delivery item, such that the status of the wordless express delivery item can be inquired through the wordless document file.

Another advantage of the invention is to provide a wordless express delivery system, wherein the wordless document file has wordless information for recording information of the corresponding express delivery item.

Another advantage of the invention is to provide a wordless express delivery system, wherein the wordless express delivery system provides a wordless information management platform, wherein the wordless information management platform acquires the wordless information from the wordless document file for inquiring the status of the wordless express delivery item corresponding to the wordless document file via the wordless information management platform.

Another advantage of the invention is to provide a wordless express delivery system, wherein the wordless express delivery system provides a wordless information management platform which provides relevant information of the express delivery item to form wordless information of the respective express delivery item.

Another advantage of the invention is to provide a wordless express delivery system, wherein the wordless information management platform is connected with an output device to output the wordless information to a carrier to form the wordless document file.

Another advantage of the invention is to provide a wordless express delivery system, wherein the wordless express delivery system provides at least one wordless information management terminal which can acquire the wordless information of the wordless document file for inquiring the status of the wordless express delivery item corresponding to the wordless document file through the wordless information management terminal.

Another advantage of the invention is to provide a wordless express delivery system, wherein the wordless information management terminal is provided to illustrate the wordless information contained in the wordless document file of the respective express delivery item.

Another advantage of the invention is to provide a wordless express delivery system, wherein the wordless information management terminal is provided for inputting the information of the express delivery item.

Another advantage of the invention is to provide a wordless express delivery system, wherein the wordless information management terminal is provided to generate the wordless document file.

Another advantage of the invention is to provide a wordless express delivery system, wherein the wordless express delivery system provides at least one wordless information management application which can be installed in an intelligent terminal, so as to acquire the wordless information of the wordless document file through the intelligent terminal.

Another advantage of the invention is to provide a wordless express delivery system, wherein the wordless information management application is capable of accessing the wordless information management platform through the intelligent terminal to acquire the wordless information of the wordless document file corresponding to the express delivery item and then display the information of the express delivery item through the intelligent terminal.

Another advantage of the invention is to provide a wordless express delivery system, wherein the wordless document file further has a carrier for setting the wordless information.

Another advantage of the invention is to provide a wordless express delivery system, wherein the wordless information is an identification.

Another advantage of the invention is to provide a wordless express delivery system, wherein the identification code is two-dimension code such as QR code.

Another advantage of the invention is to provide a paperless express delivery system, wherein the paperless express delivery system provides a paperless document file platform which forms at least one paperless document file, wherein during the express delivering, the paperless document file is able to access the paperless document file platform to amend and change receiver's information corresponding to the express delivery item through the paperless document file so as to change the express delivery route.

Another advantage of the invention is to provide a paperless express delivery system, wherein the paperless document file is outputted into a carrier which is affixed to the respective express delivery item for distinction of the express delivery item.

Another advantage of the invention is to provide a paperless express delivery system, wherein the paperless document file outputted into the carrier has no text and word marks on it to eliminate the risk of disclosing any information of the express delivery item.

Another advantage of the invention is to provide a paperless express delivery system, wherein the paperless document file is delivered to the sender and receiver by means of the identification information of the sender and the identification information of the receiver.

Another advantage of the invention is to provide a paperless express delivery system, wherein during the express delivering, the receiver may change the information of the receiver of the respective paperless document file so as to deliver the express delivery item with respect to the amended paperless document file to another receiver, and the receiver may send the paperless document file to the another receiver by means of the identification information of the another receiver, so that the express delivery item is able to be inspected and accepted by the another.

Another advantage of the invention is to provide a paperless express delivery system, wherein during the express delivering, the sender may change the information of the receiver of the respective paperless document file so as to deliver the express delivery item with respect to the amended paperless document file to another receiver, and the sender may send the paperless document file to the another receiver by means of the identification information of the another receiver, so that the express delivery item is able to be inspected and accepted by the another.

Another advantage of the invention is to provide a paperless express delivery system, wherein the paperless express delivery system provides a series of transport hubs, wherein each of the transport hubs provides a series of unmanned transportation devices, wherein the transportation between the transport hubs is operated by the unmanned transportation.

Another advantage of the invention is to provide a paperless express delivery system, wherein the transport hub is mobile transport hub which does not have a fixed location and is capable of changing its location according to the optimization of the express delivery efficiency.

Another advantage of the invention is to provide a paperless express delivery system, wherein each of the transport hubs provides a navigation center for providing navigation service for the transport hub.

Another advantage of the invention is to provide a paperless express delivery system, wherein each of the transport hubs provides at least one main transport hub and multiple sub transport hubs, wherein the transportation between the main transport hub and sub transport hubs is operated by the unmanned transportation devices, wherein the locations of the main transport hub and the sub transport hubs are movable for optimizing the express delivery efficiency.

Another advantage of the invention is to provide a paperless express delivery system, wherein the paperless express delivery system provides a route management center, wherein the route management center provides settlement of the location of the transport hub and assigns the receiving route and the sending route of the unmanned transportation device.

Another advantage of the invention is to provide a paperless express delivery system, wherein the paperless express delivery system provides a payment unit, wherein the sender and the receiver pay the express delivery service fee through the payment unit, wherein the payment unit informs the sender or the receiver the required service fee to be paid and the cost of changing the information of the receiver.

Another advantage of the invention is to provide a paperless express delivery system, wherein the paperless express delivery system provides at least one paperless document file management terminal which provides recording of the paperless document file, wherein the paperless document file management terminal provides the inputting of the information and the outputting of the paperless document file.

Another advantage of the invention is to provide a paperless express delivery system, wherein the paperless document file management terminal is detachably installed in the unmanned transportation device so as to enable the unmanned transportation device to receive and deliver the express delivery item.

Another advantage of the invention is to provide a paperless express delivery system, wherein the paperless express delivery system provides at least one paperless document file management application which is installed in the intelligent terminal, wherein the paperless document file management application is adapted to input the relevant information of the express delivery item to generate the paperless document file, wherein the paperless document file management application is able to capture and record the paperless document file by the camera of the intelligent terminal.

Another advantage of the invention is to provide a paperless express delivery system, wherein the paperless document file platform provides a paperless document file management unit and an information storage unit for acquiring the relevant information of the express delivery item and producing the paperless document file according to the relevant information of the express delivery item, wherein the paperless document file is saved and stored in the information storage unit.

Another advantage of the invention is to provide a paperless express delivery system, wherein the relevant information includes the identification information of the sender and the identification information of the receiver, wherein the paperless document file is sent to the sender and receiver according to the identification information of the sender and the identification information of the receiver by the paperless document file management unit.

Another advantage of the invention is to provide a paperless express delivery system, wherein the paperless document file management unit verifies the paperless document file so as to facilitate the receiver to receive the express delivery item.

Another advantage of the invention is to provide a paperless express delivery system, wherein route management center further provides a transport hub management unit and a route management unit, wherein the transport hub management unit settles the location of the transport hub for optimizing the express delivery efficiency, wherein the route management unit assigns the transport route of the unmanned transportation device.

Additional advantages and features of the invention will become apparent from the description which follows, and may be realized by means of the instrumentalities and combinations particular point out in the appended claims.

According to the present invention, the foregoing and other objects and advantages are attained by a wordless express delivery system, which comprising:

at least one wordless document file, wherein the wordless document file is securely affixed to an express delivery item corresponding to the wordless document file, so as to form a wordless express delivery item; and

a wordless information management platform which manages the wordless document file, wherein the wordless information management platform is able to acquire wordless information regarding to the wordless express delivery item in the wordless document file, so as to obtain a delivery status of the wordless express delivery item, wherein there is no word marking any information of the wordless document file regarding to the express delivery item on the wordless document file, so as to eliminate the risk of disclosing the information regarding the express delivery item.

The wordless express delivery system further comprises at least one wordless information management terminal, which is communicatively connected to the wordless information management platform, wherein the wordless information management terminal acquires the wordless information of the wordless document file and then send to the wordless information management platform, wherein after being processed by the wordless information management platform, the wordless information management terminal shows the wordless information of the wordless document file in form of text and word for inquiring and reading the condition and status of the wordless express delivery item corresponding to the wordless document file.

The wordless express delivery system further comprises at least one wordless information management application, which is installed in an intelligent terminal, wherein the wordless information management application is communicatively connected to the wordless information management platform via the intelligent terminal, so as to acquire the wordless information of the wordless document file through the intelligent terminal, and send to the wordless information management platform, wherein after processed by the wordless information management platform the intelligent terminal shows the wordless information of the wordless document file in words, so as to look up the status of the wordless express delivery item corresponding to the wordless document file.

The present invention further provides a method of forming a wordless express delivery item, which comprises the steps of:

(A) providing an express delivery;

(B) acquiring an express delivery item information corresponding to the express delivery item;

(C) forming a wordless document file corresponding to the express delivery item according to the express delivery item; and

(D) securely affixing the wordless document file to the express delivery item to form the wordless express delivery item.

The step (C) further comprises the steps of:

(C.1) analyzing the express delivery item information to acquire a sender information, a receiver information and an item information;

(C.2) generating a delivery route information according to the sender information, the receiver information and the item information;

(C.3) processing the delivery route information, the sender information, the receiver information and the item information and generating a wordless information delivery route information; and

(C.4) forming a wordless document file corresponding to the express delivery item by settling the wordless information on a carrier.

According to the present invention, the foregoing and other objects and advantages are attained by a paperless express delivery system, which comprises:

at least paperless document file, wherein the paperless document file records a corresponding information of an express delivery item; and

a paperless document file platform which generates the paperless document file, wherein the paperless document file platform settles the paperless document file with a carrier, wherein the carrier is securely affixed on the corresponding express delivery item to inquire the corresponding information of the express delivery item through the paperless document file on the paperless document file platform, wherein the carrier has no word mark thereon to eliminate the risk of disclosing the information of the express delivery item.

According to the present invention, the foregoing and other objects and advantages are attained by a method of consigning to receive an express delivery item, which comprises:

Step 1: amending a receiver information of a paperless document file corresponding to an express delivery item to modify the receiver information of the express delivery item to an information of a consigned receiverpaperless document fileexpress delivery item;

Step 2: sending the paperless document file to the consigned receiver according to the information of the consigned receiver;

Step 3: returning to the Step 1 if a rejection to receive the information of the express delivery item by the consigned receiver; and

Step 4: receiving the corresponding express delivery item after verifying the paperless document file.

The Step 1 further comprises the steps of:

Step 11: inquiring the receiver information of the corresponding express delivery item of the paperless document file;

Step 12: receiving a consigned receiver information of the corresponding express delivery item of the paperless document file;

Step 13: modifying the receiver information to the consigned receiver information, wherein, in other words, the information of the consigned receiver becomes a new receiver information; and

Step 14: storing the consigned receiver information in the information storage center and storing a consigner information in the information storage center.

The Step 2 further comprises the steps of:

Step 21: inquiring an identification information of the consigned receiver in the consigned receiver information;

Step 22: sending the paperless document file to the consigned receiver according to the identification information of the consigned receiver; and

Step 23: invaliding the paperless document file of the receiver.

The Step 3 further comprises the steps of:

Step 31: receiving an information of rejection of the express delivery item sent by the consigned receiver;

Step 32: sending operation tips to the consigner: modifying the corresponding receiver information to the consigner information or the consigned receiver information.

Step 33: setting the consigner information as the consigned receiver information if receiving a feedback of modifying the corresponding receiver information to the consigner information, and then returning to the Step 1; and

Step 34: returning to the Step 1 if receiving a feedback of modifying the receiver information.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a wordless express delivery system according to a preferred embodiment of the present invention.

FIG. 2 is a flow diagram illustrating the forming of a wordless document file according to a wordless express delivery system of the above preferred embodiment of the present invention.

FIG. 3 is a flow diagram illustrating the forming of a wordless express delivery item according to the wordless express delivery system of above preferred embodiment of the present invention.

FIG. 4 is another flow diagram illustrating the wordless express delivery item according the wordless express delivery system of the above preferred embodiment of the present invention.

FIG. 5 is a flow diagram illustrating the forming of a wordless document file of a wordless express delivery item according to the wordless express delivery system of the above preferred embodiment of the present invention as shown in FIG. 2. wordless express delivery system.

FIG. 6 is a flow diagram illustrating the forming of a wordless document file of a wordless express delivery item according to the wordless express delivery system of the above preferred embodiment of the present invention as shown in FIG. 3 wordless express delivery system.

FIG. 7 is a block diagram of a wordless express delivery system according to another preferred embodiment of the present invention.

FIG. 8 is a block diagram of a wordless information management terminal of the wordless express delivery system according to another preferred embodiment of the present invention.

FIG. 9 is a schematic view of the wordless information management terminal of the wordless express delivery system according to another preferred embodiment of the present invention.

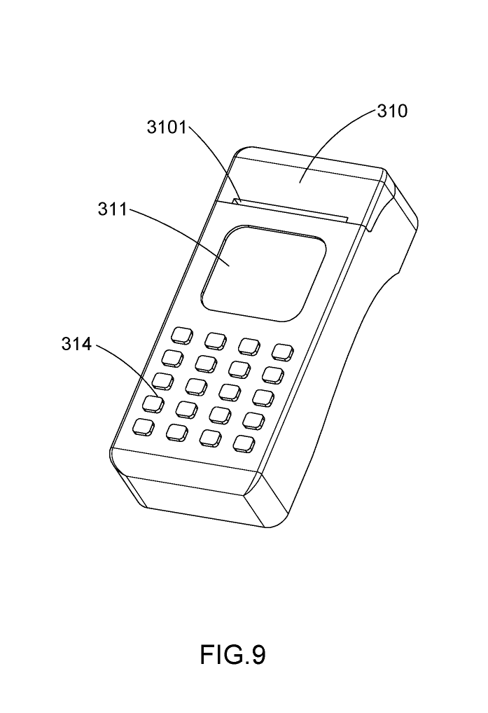

FIG. 10 is a rear view of the wordless information management terminal of the wordless express delivery system according to another preferred embodiment of the present invention.

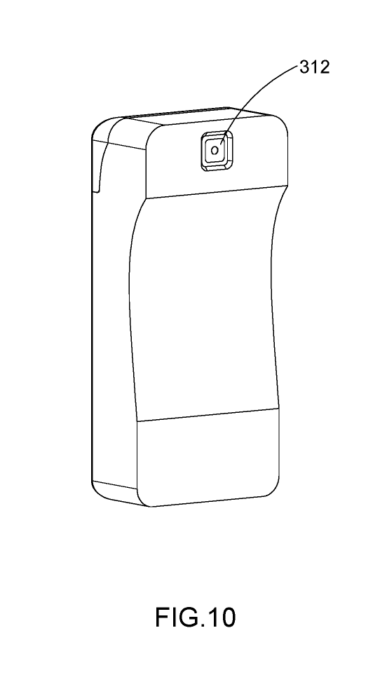

FIG. 11 is a block diagram of a paperless express delivery system according to a preferred embodiment of the present invention.

FIG. 12 is a schematic view of the wordless information management terminal of the paperless express delivery system according to another preferred embodiment of the present invention.

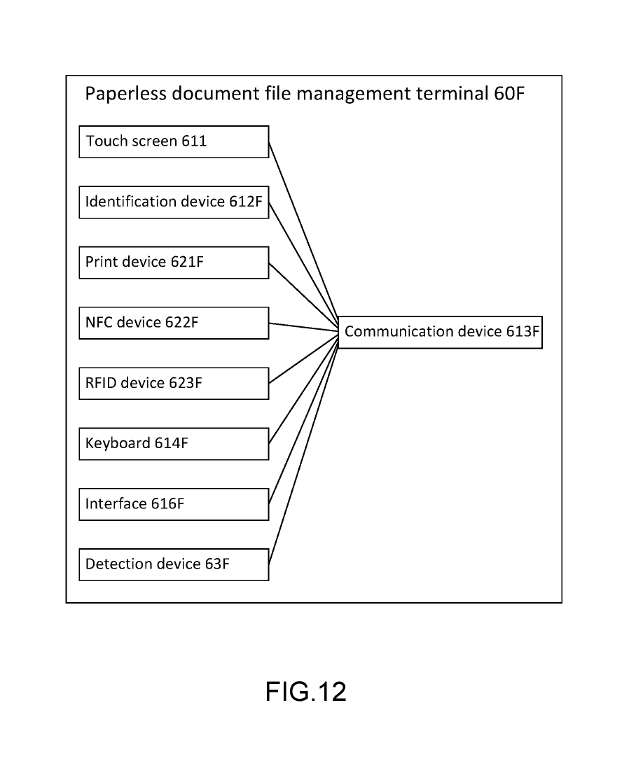

FIG. 13 is a schematic view of the paperless information management terminal of the paperless express delivery system according to another preferred embodiment of the present invention.

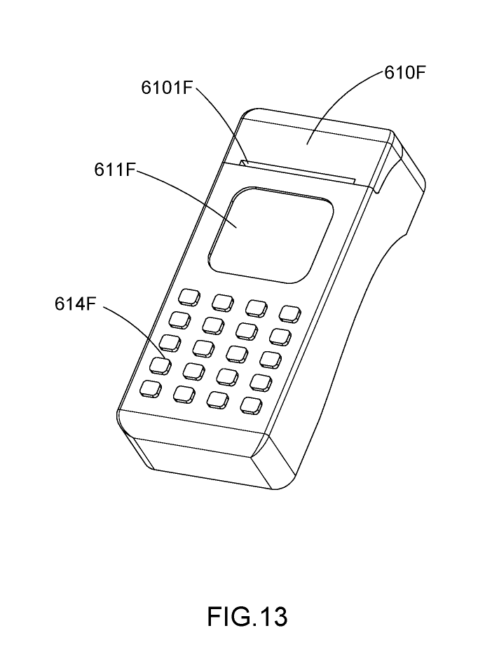

FIG. 14 is a rear view of the paperless information management terminal of the paperless express delivery system according to another preferred embodiment of the present invention.

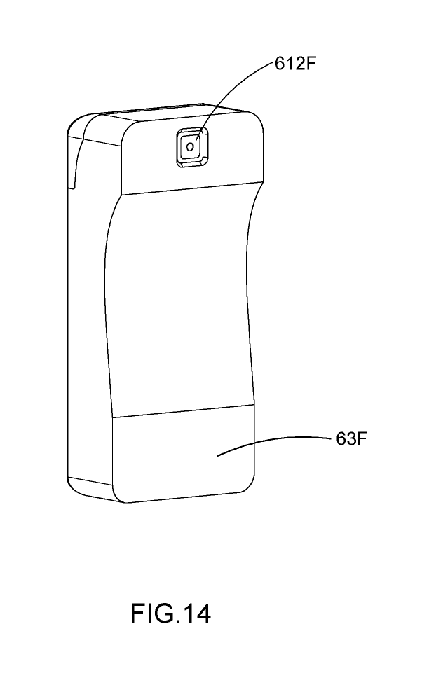

FIG. 15 is a flow diagram illustrating a method of consigning to receive the express delivery item according to another preferred embodiment of the present invention.

FIG. 16 is a flow diagram illustrating another method of consigning to receive the express delivery item according to another preferred embodiment of the present invention

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

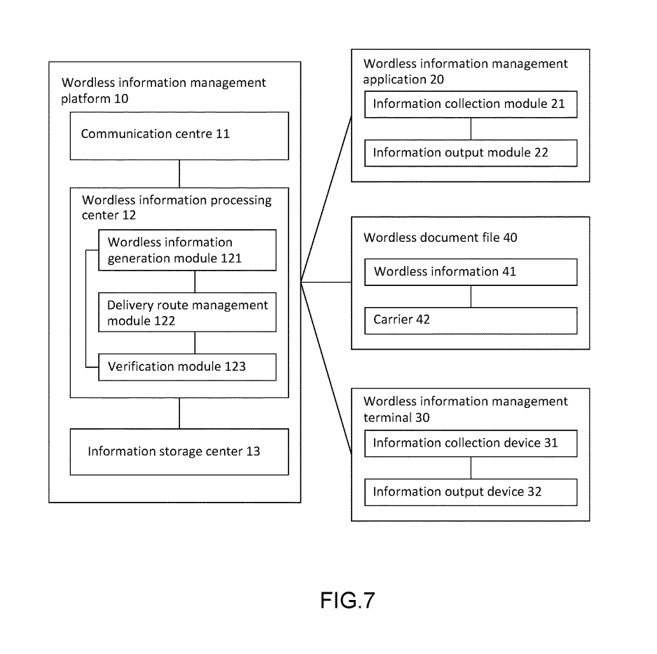

FIG. 7 is a block diagram of a wordless express delivery system according to a preferred embodiment of the present invention. The wordless express delivery system comprises a wordless information management platform 10 and at least one wordless document file 40, wherein the wordless information management platform 10 is communicatively connected to the wordless document file 40 for acquiring the information of the wordless document file 40. The wordless information management platform 10 manages the at least one wordless document file 40. The wordless document file 40 is securely affixed on the express delivery item and records the corresponding information of an express delivery item. It is worth mentioning that the wordless document file 40 does not have any text or word marking the corresponding information of the express delivery item thereon, so as to avoid the information recorded in the wordless document file 40 from being acquired directly by viewing and reading and thus eliminate the risk of disclosing any information regarding the express delivery item. After the wordless document file 40 is acquired by the wordless information management platform 10, the wordless document file 40 is processed to analyze the information of the express delivery item, such as the sender information, the receiver information and the relevant information of the express delivery item. The wordless information management platform 10 arranges one or more couriers to collect or deliver the express delivery item according to the express delivery item information. The wordless information management platform 10 enables the input of the information of the express delivery. The wordless information management platform 10 receives the information of the express delivery written by a user and then processes the information of the express delivery to form the wordless document file 40 correspondingly. The user securely affixes the wordless document file 40 on the corresponding express delivery item to form a wordless express delivery item. It is worth mentioning that, if both the sender and the receiver have not registered before the wordless information management platform 10, the wordless information management platform 10 analyzes the information of the express delivery item to acquire the information of the sender and the receiver. Then the sender and the receiver are registered on the wordless information management platform 10. The wordless information management platform 10 processes the information of the sender and the receiver to respectively form a wordless information of the identity information of the sender and a wordless information of the identity information of the receiver. Alternatively, the first wordless document file generated is set as an identification information for identity, which helps to determine an identity of the express delivery service provider. Preferably, the identification information for identity is a telephone number.

The paperless information management platform 10 further comprises a communication center 11, a wordless information processing center 12 and an information storage center 13. The communication center 11 is communicatively connected to the wordless information processing center 12. The wordless information processing center 12 is communicatively connected to the information storage center 13. The communication center 11 supports the wordless information management platform 10 to communicate with the user. The communication center 11 receives the information of the express delivery item inputted by the user through the wordless information management platform 10, and then sends the information of the express delivery item to the wordless information processing center 12. The wordless information processing center 12 processes the information of the express delivery item to acquire the receiver information, the sender information and the item information. Then, the wordless information processing center 12 verifies whether the receiver and the sender have been registered in the wordless information management platform 10. The information storage center 13 conducts a search in the information storage center 13 according to the receiver information. If the information storage center 13 has the receiver information, it means the receiver has been registered in the wordless information management platform 10. If the information storage center 13 doesn't have the receiver information, the wordless information processing center 12 will register the receiver as a registered user of the wordless information management platform 10. Thereafter, the wordless information processing center 12 processes the receiver information to generate a wordless information regarding the receiver identity for identifying the receiver. The wordless information processing center 12 stores the wordless information regarding the receiver identity in the information storage center 13. The wordless information processing center 12 processes the information of the sender similar to the information of the receiver as described above. The wordless information processing center 12 acquires an information of an express delivery service provider from the information storage center 13. The wordless information processing center 12 processes the information of the express delivery service provider according to the sender information and the receiver information and generates a delivery route information. It is worth mentioning that, as the wordless information processing center 12 is processing the information of the express service provider, the delivery route is optimizing to improve the delivery efficiency. In addition, the wordless information processing center 12 assigns an information of each executing person of each delivery section according to the information of the express delivery service provider. Finally, the wordless information processing center 12 programs the receiver information, the sender information, the delivery route information, and the information of each executing person in each delivery section to generate a wordless information 41. It is worth mentioning that the communication center 11 may receive a picture of the express delivery item as an express delivery item information to facilitate the receiver to verify the express delivery item when receiving it. The communication center 11 sends the wordless information 41 to the sender and the receiver to facilitate the sender and the receiver to check and inquire the status and condition of the express delivery item during the delivery of the express delivery item. The communication center 11 sends the wordless identification information of the receiver and the wordless identification information of the sender to the receiver and the sender respectively. The wordless information processing center 12 also sends the wordless information 41 to the communication center 11. The communication center 11 settles the wordless information 41 on a carrier 42 to form a wordless document file 40. Then, the wordless document file 40 is securely affixed on the corresponding express delivery item to form a wordless express delivery item. It is worth mentioning that, if the carrier 42 is big enough to contain the corresponding express delivery item, the wordless document file 40 can be used to pack up the express delivery item to better protect the express delivery item. In other words, the carrier 42 can receive the express delivery item therein to provide protection of the express delivery item. It is worth mentioning that the wordless document file 40 can also be directly and securely affixed on the express delivery item. Preferably, the wordless document file 40 is directly and securely affixed on the express delivery item by adhesive. It is worth mentioning that the wordless information 41 can be provided directly on the corresponding express delivery item. In other words, the carrier 42 of the wordless information 41 can be the express delivery item itself. Preferably, the wordless information 41 is printed on the express delivery item.

The wordless information processing center 12 further comprises a wordless information generation module 121, a delivery route management module 122 and a verification module 123. The wordless information generation module 121 is communicatively connected to the delivery route management module 122. The delivery route management module 122 is communicatively connected to the verification module 123. The wordless information generation module 121 is communicatively connected to the verification module 123. The verification module 123 receives the information of the express delivery item sent by the communication center 11. The verification module 123 analyzes the information of the express delivery item to acquire the sender information, the receiver information and the information of the express delivery item. The verification module 123 separately verifies the sender and the receiver whether registered on the wordless information management platform 10. If the sender is not registered on the wordless information management platform 10, the verification module 123 registers the sender and generates a wordless identity information of the sender according to the sender information for identifying the sender. Then the wordless identity information of the sender is stored to the information storage center 13. If the sender is registered on the wordless information management platform 10, the verification module 123 acquires the wordless identity information of the sender from the information storage center 13, then the wordless identity information of the sender is sent to the wordless information generation module 121. If the receiver is not registered on the wordless information management platform 10, the verification module 123 register the receiver and form the wordless information 41 regarding a identity information of the receiver according to the receiver information for identifying the receiver. Then the wordless information 41 of the receiver is stored to the information storage center 13. If the receiver is registered on the wordless information management platform 10, the verification module 123 acquires the wordless information 41 regarding the identity information of the receiver from the information storage center 13, then the wordless identity information of the receiver is sent to the wordless information generation module 121. The verification module 123 separately sends the information of the express delivery item, the sender and the receiver to the delivery route management module 122. The delivery route management module 122 acquires the information of the express delivery supplier from the information storage center 13, and process with the sender information, the receiver information, and the express delivery item information to form a delivery route information. The corresponding express delivery item is delivered as the route of the delivery route information. It is worth mentioning that the delivery route management module 122 processes the information of the express delivery supplier, the sender information, the receiver information, and the information of the express delivery item and form at least one delivery route. Then the delivery route management module 122 selects preferably one of the delivery routes to form the information of delivery information. Further more, the delivery route management module 122 assigns the delivering man and the delivering time in every delivering point according to the delivery route, so as to inquire the status of the express delivery item. The delivery route management module 122 sends the delivery route information to the wordless information generation module 121. The wordless information generation module 121 processes the delivery route information, the sender information, the receiver information and the information of express delivery item to form a wordless information 41. Preferably, the wordless information generation module 121 processes the delivery route information, the sender information, the receiver information and the information of the delivery item in encoding and encrypting way to form the wordless information 41. Then the wordless information generation module 121 sends the wordless information 41, the wordless identity information of the sender and the wordless identity information of the receiver to the communication center 11. The communication center 11 sends the wordless identity information of the sender and the wordless information 41 to the sender. The communication center 11 sends the wordless identity information of the sender and the wordless information 41 to the receiver. The communication center 11 sends the wordless information 41 to the assigned express delivery supplier to inform the express delivery supplier to provide service. The communication center 11 sets the wordless information 41 on the carrier 42 to form a wordless document file 40. Then the wordless document file 40 is securely set on the corresponding express delivery item to form a wordless express delivery item.

As the wordless express delivery item being sorting, the wordless information management platform 10 acquires the wordless information of the wordless document file 40 corresponding to the express delivery item by the communication center 11. The wordless information processing center 12 receives the wordless information from the communication center 11 and processes the wordless information to acquire the delivery route information. Then the wordless information processing center 12 analyzes the delivery route information to acquire the information of next destination. Then the wordless express delivery item is sorted to the wordless express delivery items with the same next destination. It is worth mentioning that, if the delivery route information has the information of the delivery man, the wordless information management platform 10 informs the express delivery supplier of next destination by communication centre 11 about the information to deliver the wordless express delivery item.

Preferably, the wordless information 41 is an identification code. In other words, the wordless information generation module 121 processes the relevant information of the delivery route, the sender, the receiver and the express delivery item to form the corresponding identification code. Then the corresponding identification code is sent to the communication center 11. The communication center 11 sets the identification code on a carrier 42 to form a wordless document file 40. It is worth mentioning that the identification code is set on the corresponding express delivery item to form wordless document file 40. In other words, the express delivery item can be the carrier 42 of the identification code. The communication center 11 set the identification code on the carrier 42 by means selected from printing, carving and storing. Preferably, the communication center 11 prints the identification code on the carrier 42 to form the wordless document file 40. It is worth mentioning that the carrier 42 can be the corresponding express delivery item. In other words, the identification code corresponding to the express delivery item can be printed on the express delivery item to form the wordless document file 40. Preferably, the identification code is a two-dimension code. The wordless information generation module 121 processes the relevant information of the delivery route, the sender, the receiver and the express delivery item to form the corresponding two-dimension code. Then the corresponding two-dimension code is sent to the communication center 11. The communication center 11 sets the two-dimension code on a carrier 42 to form a wordless document file 40. It is worth mentioning that the two-dimension code is set on the corresponding express delivery item to form the wordless document file 40. In other words, the express delivery item can be the carrier 42 of the two-dimension code for forming the wordless document file 40. The communication center 11 set the two-dimension code on the carrier 42 by means selected from printing, carving and storing. Preferably, the communication prints the two-dimension code on the carrier 42 to form the wordless document file 40. It is worth mentioning that the carrier 42 can be the corresponding express delivery item. In other words, the two-dimension code corresponding to the express delivery item can be printed on the express delivery item to form the wordless document file 40. The carrier 42 further comprises an identification portion 421 and a connection potion carrier 422. The identification portion 421 is provided to set the wordless information 41 to identify the wordless document file 40 on the position of the corresponding express delivery item. At the same time, the wordless information 41 can be directly printed on the identification portion 421 to identify the wordless information 41. It is worth mentioning that the identification portion 421 can be provided on a NFC (Near Field Communication) device to store the wordless information 41 in the NFC (Near Field Communication) device. So the identification portion 421 needs no information in words. It is worth mentioning that the identification portion 421 can be provided on a RFID device. The wordless information 41 can be stored in the RFID device for inquiring.

The wordless express delivery system of the present invention further comprises a wordless information management terminal 30. The wordless information management terminal 30 is communicatively connected with the wordless information management platform 10. Preferably, the wordless information management terminal 30 is connected with the wordless information management platform 10 via communication network for the wordless information management terminal 30 communicating with the wordless information management platform 10. The wordless information management terminal 30 can inquire the wordless information 41 of the wordless document file 40 and send the wordless information 41 to the wordless information management platform 10 to identify the wordless information of wordless document file 40 through wordless information management platform 10. The wordless information management platform 10 acquires corresponding the receiver information of the wordless document file 40, corresponding the sender information of the wordless document file 40 and corresponding the information of the express delivery item of the wordless document file 40 through processing the wordless information. The wordless information management platform 10 sends the receiver information, the sender information and the information of the express delivery item to the wordless information management terminal 30. The wordless information management terminal 30 shows the receiver information, the sender information and the information of the express delivery item for inquiring. The wordless information management terminal 30 is capable of receiving the wordless information 41 sent by the wordless information management platform 10. Then the wordless information 41 is set on a carrier 42 to form a wordless document file 40. The wordless document file 40 is secured on the corresponding express delivery item to form the wordless express delivery item.

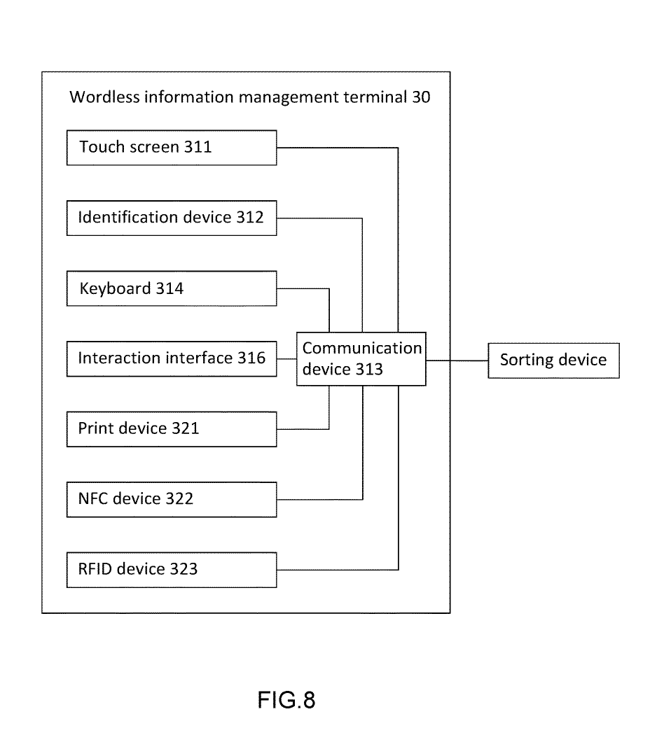

The wordless information management terminal 30 further comprises at least one information acquisition device 31 and at least one information output device 32. The information acquisition device 31 is communicatively connected to the information output device 32. The information acquisition device 31 acquires the wordless information 41 of the wordless document file 40. Then the wordless information 41 is sent to the communication center 11 of the wordless information management platform 10. The communication center 11 receives the wordless information 41 and sends the wordless information 41 to the wordless information processing center 12. The wordless information processing center 12 processes the wordless information 41 to acquire the receiver information, the sender information and the information of the express delivery item. Furthermore, the wordless information generation module 121 of the wordless information processing center 12 interprets the wordless information 41 to acquire the receiver information, the sender information, the information of the express delivery item and the delivery route information. The wordless information generation module 121 sends the receiver information, the sender information, the information of the express delivery item and the delivery route information to the communication center 11. Then the communication center 11 returns to the wordless information management terminal 30. The information acquisition device 31 acquires the receiver information, the sender information, the information of the express delivery item and the delivery route information and sends to the information output device 32. The information output device 32 selectively outputs the receiver information, the sender information, the information of the express delivery item and the delivery route information for inquiring. The wordless information management terminal 30 sets the wordless information 41 on the carrier 42 by the information output device 32 to form the wordless document file 40. It is worth mentioning that the information acquisition device 31 comprises, but not limited, touch screen, display screen, keyboard and scanning device. As shown in FIG. 8, the wordless information management terminal 30 configures three kinds of the information acquisition device 31: a touch screen 311, a camera 312 and a communication device 313. Also, the touch screen 311 is capable of being the information output device for outputting information. The wordless information management terminal 30 further comprises an information output device 32. The information output device 32 is preferred to be a print device.

As shown in FIG. 8, preferably, the wordless information management terminal 30 comprises a touch screen 311, an identification device 312, a communication device 313 and a print device 321. The communication device 313 is separately communicatively connected with the touch screen 311, the identification device 312 and the print device 321. The identification device 312 is preferred to be the camera. The touch screen 311 is provided to input the information of the express delivery item and shown the information of the express delivery item and the wordless document file 40 in texts/words. The identification device 312 acquires the wordless information 41 of the wordless document file 40. Then the wordless information 41 is sent to the wordless information management platform 10 through the communication device 313. Through processing by the wordless information management platform 10, the wordless information 41 corresponding to the express delivery item is acquired. Then the information of the express delivery item is sent to the touch screen 311 for displaying and inquiring. The information of the express delivery item is acquired from the express delivery item, and sent to the wordless information management platform 10 by the communication device 313. Through processing by the wordless information management platform 10, the wordless information 41 corresponding to the express delivery item is acquired. The corresponding wordless information 41 is sent to the touch screen 311 through the communication device 313, for the touch screen 311 displaying the corresponding wordless information 41. It is worth mentioning that the wordless information 41 is capable of being sent to the print device 321 through the communication device 311. The print device 321prints the wordless information 41 on a carrier 42 to form a wordless document file 40. Preferably, the carrier 42 is a paper product to secure the wordless document file 40 to the corresponding express delivery item. Preferably, the paper product is a paper having a spliced surface for securing the wordless document file 40 on the corresponding express delivery item. The camera 312 can acquire the wordless information 41 printed on the paper and sent the wordless information 41 to the wordless information management platform 10. It is worth mentioning that the camera 312 can take the picture of the express delivery item and sent to the wordless information management platform 10. In other words, the information of the express delivery item can have pictures. The wordless information management platform 10 is capable of processing the picture information.

The wordless information management terminal 30 further comprises a NFC device 322. The NFC device 322 is communicatively connected to the communication device 313for acquiring the wordless information 41 of the wordless document file 40 of the carrier 42 which carried on the NFC device 322. The wordless information 41 is sent to the wordless information management platform 10 by the communication device 313. The wordless information management platform 10 processes the wordless information 41 to acquire the corresponding the information of express delivery item. The corresponding express delivery item is sent to the touch screen 311 by the communication device 313 for showing the corresponding information of express delivery item in texts/words. The NFC device 322 is capable of acquiring the wordless information 41 from the wordless information management platform 10 through the communication device 313, and configures the wordless document file 40, wherein the carrier 42 of the wordless document file 40 is the NFC device.

The wordless information management terminal 30 further comprises a RFID device 323. The RFID device 323 is communicatively connected to for acquiring the wordless information 41 of the wordless document file 40 of the carrier 42 which carried on the RFID device 323. The wordless information 41 is sent to the wordless information management platform 10 by the communication device 313. The wordless information management platform 10 processes the wordless information 41 to acquire the information of the corresponding express delivery item. The information of the corresponding express delivery item is sent to the touch screen 311 through the communication device 313 for displaying the information of the corresponding express delivery item in texts/words. The RFID device 323 is capable of acquiring the wordless information 41 from the wordless information management platform 10 through the communication device 313, and configures the wordless document file 40, wherein the carrier 42 of the wordless document file 40 is the RFID device.

The wordless information management terminal 30 further comprises a keyboard 314. The keyboard 314 is communicatively connected to the communication device 313 for inputting information. The identification device 312 can be a scanning device. The wordless information management terminal 30 further comprises a housing 310. The housing 310 has an opening 3101 for acquiring the wordless document file 40, wherein the print device 321 prints the wordless information 41 to the papery carrier 42 to form the wordless document file 40. The touch screen 311, the keyboard 314 and the camera 312 are secured on the housing 310 for displaying information and inputting information. Preferable, the camera 312 is configured on the rear of the housing 310.paperless information management platform 10F

The wordless information management terminal 30 further comprises an interaction interface 316, which is communicatively connected to the communication device 313. It is worth mentioning that the interaction interface 316 is capable of externally connecting a sorting device for controlling the sorting device to sort the wordless express delivery item through the wordless express delivery system of the present invention.

It is worth mentioning that the wordless information management terminal 30 can verify the identity of the express delivery supplier. The wordless information management platform 10 provides each of the express delivery suppliers a wordless identity information for identifying the express delivery supplier. The wordless identity information is set on the carrier to form a wordless document identity file. The information acquisition device 31 of the wordless information management terminal 30 acquires the wordless identity of the express delivery supplier, and the wordless identity information is sent to the communication center 11 of the wordless information management platform 10. The communication center 11 sends the wordless identity information to the wordless information processing center 12. The verification module 123 of the wordless information processing center 12 verifies the wordless identity information. The verification module 123 searches the corresponding identity information to the wordless identity information in the information storage center 13. If there is the corresponding identity information to the wordless identity in the information storage center 13, the verification module 123 acquires the corresponding identity information from the information storage center 13 and sends to the wordless information management terminal 30 via the communication center 11. The information acquisition device 31 of the wordless information management terminal 30 receives the corresponding identity information and sends to the information output device 32 to show the corresponding identity information by the information output device 32. Furthermore, by verifying the identity of the express delivery supplier, the information of the wordless express delivery item is controlled to show on the wordless information management terminal 30. In other word, if the wordless express delivery item is served by the assigned express delivery supplier, only the assigned express delivery supplier can acquire the information of the wordless express delivery item. The other express delivery supplier can not acquire the information of the wordless express delivery item, so as to reduce the risks of disclosing the information of the express delivery item. The information acquisition device 31 of the wordless information management terminal 30 separately acquires the wordless information 41 and the wordless identity information of the wordless document file 40. Then the wordless information and the wordless identity information corresponding to the express delivery item are sent to the communication center 11 of the wordless information management platform 10. Then the wordless information and the wordless identity information corresponding to the express delivery item send to the wordless information processing center 12 through the communication center 11. The wordless information generation module 121 of the wordless information processing center 12 receives the wordless information and the wordless identity information. The wordless information generation module 121 processes the wordless information to acquire the delivery route information, identity of the assigned express delivery supplier in each part of the delivery route and the identity information of the express delivery supplier. Then the wordless information processing center 12 sends the delivery route information, identity information of the assigned express delivery supplier in each part of the delivery route and the identity information of the express delivery supplier to the verification module 123. The verification module 123 verifies identity of the assigned express delivery supplier in each part of the delivery route whether having the identity information of the express delivery supplier. If the assigned express delivery supplier in each part of the delivery route having the identity information of the express delivery supplier, the relevant information of the wordless express delivery item is shown to the express delivery supplier via the information output device 32 for verifying. In other words, the wordless information management terminal 30 is selectively shown the information of the wordless express delivery item. Only the assigned express delivery supplier of delivering the wordless express delivery item can inquire the relevant information of the wordless express delivery item.

The wordless information management terminal 30 is provided to input the relevant information of the express delivery item. The wordless information management terminal 30 is provided to receive the relevant information of the express delivery item acquired from the express delivery item. The sender can input the relevant information of the express delivery item through the wordless information management terminal 30, such as the sender information, the receiver information and the information of the express delivery item. Also the express delivery item can be took pictures to verify the express delivery item by the receiver. The information acquisition device 31 of the wordless information management terminal 30 receives the relevant information of the express delivery item and sends to the paperless information management platform 10For processing. The wordless information management platform 10 processes the relevant information of the express delivery item to acquire the wordless information, and sends the wordless information to the wordless information management terminal 30. The wordless information management terminal 30 sets the wordless information on a carrier 42 to form the corresponding wordless document file 40. Then the wordless document file 40 is secured on the express delivery item to form the wordless express delivery item.

The wordless express delivery system of the present invention further comprises at least a wordless information management application 20. The wordless information management application 20 is communicatively connected to the wordless information management platform 10. The wordless information management application 20 is provided to input the information of the express delivery item and the input information of the express delivery item is sent to the wordless information management platform 10 to process. After the corresponding wordless information is acquired through processing the input information of the express delivery item by the wordless information management platform 10, then the wordless information management platform 10 sends the wordless information to the wordless information management application 20. The wordless information management application 20 is capable of displaying the wordless information for inquiring. The wordless information management application 20 provides to collect the wordless information of the wordless document file 40 and sends the wordless information of the wordless document file 40 to the wordless information management application 20. The wordless information management platform 10 processes the wordless information to acquire the corresponding the receiver information, the corresponding the sender information, the corresponding information of the express delivery item and the corresponding information of the delivery route. The wordless information management platform 10 sends the corresponding the receiver information, the corresponding the sender information, the corresponding information of the express delivery item and the corresponding information of the delivery route to the wordless information management application 20. The wordless information management application 20 is capable of displaying the corresponding the receiver information, the corresponding the sender information, the corresponding information of the express delivery item and the corresponding information of the delivery route for inquiring.

The wordless information management application 20 further comprises an information collection module 21 and an information output module 22. The information collection module 21 is communicatively connected to the information output module 22. The information collection module 21 is provided to input the relevant information of the express delivery item and the input the relevant information of the express delivery item is sent to the wordless information management platform 10. The wordless information management platform 10 processes the relevant information to acquire the wordless information. Then the wordless information management platform 10 sends the wordless information to the information collection module 21. The information collection module 21 sends the corresponding wordless information to the information output module 22 for displaying the wordless information through the information output module 22. The information collection module 21 can receives the receiver information, the sender information, the information of the express delivery item and the information of the delivery route sent by the wordless information management platform 10. Then the receiver information, the sender information, the information of the express delivery item and the information of the delivery route sent to the information output module 22 for the information output module 22 showing the wordless information.

The wordless information management application 20 is installed on a terminal acquire information and show information through utilizing the device of the terminal. The terminal has processing device (such as CPU) and storage device (such as ROM and RAM) for installation and operation. Preferably, the terminal is an intelligent terminal, such as intelligent phone, table PC and so on. The wordless information management application 20 provides the user to register in the wordless information management application 20. It is worth mentioning that the user can be registered user and/or register express delivery supplier through registering in the wordless information management platform 10 by the wordless information management application 20. The information collection module 21 of the wordless information management application program 20 utilizes the input device of the terminal (such as touch screen or keyboard) to input the register information of the user. The user selects the identity when inputting the register information. In other words, the user is selectively to be registered user or register express delivery supplier, or registered user and register express delivery supplier at the same time. The wordless information management platform 10 receives the register information of the user sent by the wordless information management application 20. Then the wordless information management platform 10 generates the corresponding wordless identity information according to the register information of the user. It is worth mentioning that if the user registers to be registered user and register express delivery supplier at the same time, the wordless information management platform 10 generates corresponding wordless identity information according to the identity of the registered user, and forms corresponding wordless identity information according to the identity of the registered express delivery supplier. In other words, each of the registered identity is corresponding to a wordless identity information.

The information collection module 21 of the wordless information management application program 20 utilizes the device of the terminal installed the wordless information management application 20 for the registered user inputting the information of an express delivery item. The information collection module 21 collects the information of the express delivery item input by the registered user and sends to the wordless information management platform 10. The communication center 11 of the wordless information management platform 10 receives the information of the express delivery item and sends to the wordless information processing center 12. The verification module 123 of the wordless information processing center 12 analyzes the information of the express delivery item to acquire the sender information, the receiver information and the information of the express delivery item. Then the verification module 123 verifies the sender and the receiver whether registered on the wordless information management platform 10. If the sender and the receiver is registered on the wordless information management platform 10, the verification module 123 separately sends the information of the express delivery item, the sender information and the receiver information to the delivery route management module 122. The delivery route management module 122 generates a plurality of delivery route information in accordance with the sender information, the receiver information and the information of the registered express delivery supplier selected from the information storage module 13. Then the plurality of delivery route information is sent to the information collection module 21 of the wordless information management application program 20 via the communication module 11. The information collection module 21 sends the plurality of delivery route information to the information output module 22. The information output module 22 utilizes the output device of the terminal to display the plurality of delivery route information for the registered user selecting the delivery route. After the registered user has the information of confirmed the delivery route, the information collection module 21 receives the information of confirmed delivery route, and sends the information of confirmed delivery route to the wordless information processing center 12 via the communication module 11. Then the wordless information processing center 12 sends the sender information, the receiver information, the information of the express delivery item, the information of confirmed delivery route and the information of registered express delivery supplier in the confirmed delivery route to the wordless information generation module 121. The wordless information generation module 121 processes the sender information, the receiver information, the information of the express delivery item, the information of the confirmed delivery route and the information of registered express delivery supplier in the confirmed delivery route to generate corresponding the wordless information. The wordless information generation module 121 sends the generated wordless information to the communication center 11. The communication center 11 respectively sends the wordless information to the sender and the receiver according to the sender information and the receiver information for inquiring by the sender and the receiver. It is worth mentioning that if the registered user is not the sender and the receiver, the registered user can select to choose whether to receive the wordless information corresponding to the express delivery item when writing the information of the express delivery item. Receiving the wordless information corresponding to the express delivery item is default choose. It is worth mentioning that when the registered user writing the information of the express delivery item, the condition of delivery can be selected, such as the delivery time, delivery cost, delivery way and the assigning the registered express delivery supplier. After the delivery route management module 122 generated a plurality of the delivery route, it is optimized to choose a delivery route information according to the condition of delivery as the registered user chose. Then the delivery route information is sent to the wordless information generation module 121 for generating the wordless document file 40. The communication center 11 of the wordless information management platform 10 informs a registered express delivery supplier to receive the express delivery item. The registered user set the wordless information on the carrier 42 via the wordless information management application 20 to generate a wordless document file 40. The wordless document file 40 is secured on the express delivery item to form a wordless express delivery item. Or, as the registered express delivery supplier receiving the express delivery item, the registered express delivery supplier acquire the wordless identity information of the registered user through acquiring the wordless identity file of the registered by utilizing the wordless information management terminal 30. Then the wordless information management terminal 30 sends the wordless identity information to the wordless information management platform 10. The wordless information management platform 10 verifies the wordless identity information to confirm the one is received express delivery item is the registered user. Then the wordless information management platform 10 sends the wordless information corresponding to the express delivery item to the wordless information management terminal 30. The information output device 32 of the wordless information management terminal 30 set the wordless information on a carrier 42 to generate the wordless document file 40. Then the wordless document file 40 is secured on the express delivery item to form a wordless express delivery item. It is worth mentioning that the registered user acquires the identity information of the registered express delivery supplier through the wordless information management application 20 installed on a terminal. Then the identity information of the registered express delivery supplier is sends to the wordless information management platform 10 to verify the identity information of the registered express delivery supplier, so that the security of the express delivery item is improved. It is worth mentioning that the information collection module 21 of information collection module 21 can collect the information of the wordless information management application program 20 installed on the terminal to assistantly verify the identity of the user. For instance, the wordless information management application 20 is installed on an intelligent phone. The information collection module 21 of the wordless information management application 20 can acquire the phone number of the intelligent phone and sends to the wordless information management platform 10. The wordless information management platform 10 judges the phone number whether is the phone number recorded in the identity information of the user. If the phone number is the phone number recorded in the identity information of the user, the identity of the user is verified successfully.

The registered express delivery supplier separately acquires the wordless identity information of the registered express delivery supplier, the wordless information 41 of the wordless document file 40 and the wordless identity information of the registered user through the wordless information management terminal 30. Then sends the wordless identity information of the registered express delivery supplier, the wordless information 41 of the wordless document file 40 and the wordless identity information of the registered user to the wordless information management platform 10. The verification module 123 of the wordless information processing center 12 of the wordless information management platform 10 verifies the wordless information whether has the information of the registered user, and the information of the express delivery supplier. If the wordless information has the information of the registered user and the information of the express delivery supplier, the wordless information management platform 10 confirms that the express delivery item has been received and signed.

The wordless information management terminal 30 also can be applied on the transport hub. When the wordless express delivery item has passed through the information acquisition device 31 of the wordless information management terminal 30, the information acquisition device 31 acquires the wordless information 41 of the wordless document file 40 corresponding to the express delivery item. Then the acquired wordless information is sent to the communication center 11 of the wordless information management platform 10. The communication center 11 of the wordless information management platform 10 is sent the wordless information to the wordless information processing center 12. The wordless information generation module 121 of the wordless information processing center 12 analyzes the wordless information 41 to acquire the sender information, the receiver information and the information of the delivery route. Then the delivery route is sent to the delivery route management module 122. The delivery route management module 122 analyzes the delivery route to acquire the information of the next destination and the assigned registered express delivery supplier, and the delivery route management module 122 updates the delivery route to update the status of the express delivery item for inquiring. Then the express delivery items with the same destination are delivered together. It is worth mentioning that before the registered express delivery supplier delivering the wordless express delivery item, the identity of the registered express delivery supplier needs to be verified. After the registered express delivery supplier received the wordless express delivery item, the wordless information 41 of the wordless document file 40 corresponding to the wordless express delivery item is updated for updating the status of the wordless express delivery item. As the status of the wordless express delivery item is changed, the communication center 11 of the wordless information management platform 10 sends the status of the wordless express delivery item to the sender, the receiver or the wordless information management application 20 of the terminal that the registered user submitted the to corresponding information of the wordless express delivery item. As the wordless information management application program 20 is used, the updated status of the wordless express delivery item is shown.

The sender of the corresponding wordless express delivery item, the receiver of the corresponding express delivery item or the registered user submitted the corresponding express delivery information can inquire the status of the wordless express delivery item through acquire the wordless information corresponding to the wordless express delivery. The wordless information 41 corresponding to the wordless express delivery item is acquired by the wordless information management application 20. Then the wordless information management application 20 sends the wordless information 41 to the wordless information management platform 10 to inquire the status of the wordless express delivery item. The communication center 11 of the wordless information management platform 10 sends the wordless information 41 corresponding to the wordless express delivery item to the wordless information processing center 12 for processing. The wordless information generation module 121 of the wordless information processing center 12 analyzes the wordless information 41 of the wordless express delivery item to acquire the sender information, the receiver information, the delivery route data and the registered user submitted the information of the express delivery item. Then the wordless information generation module 121 sends the delivery route data to the delivery route management module 122, and sends the sender information, the receiver information and the registered user submitted the information of the express delivery item to the verification module 123. The verification module 123 acquires the information of the registered user of the wordless information management application 20 through the communication center 11. Then the verification module 123 verifies the information of the registered user whether matches one of the sender information, the receiver information or the information of the registered user submitted the information of the express delivery item. If the information of the registered user matches one of the sender information, the receiver information and the information of registered user submitted the information of the express delivery item, the delivery route management 122 analyzes the delivery route and acquires the delivery status of the express delivery item. And the delivery status of the express delivery item is sent to the wordless information management application 20 via the communication center 11. The delivery status of the express delivery item is shown via the wordless information management application 20. If the registered user of the wordless information management application program 20 is not the receiver, the sender, or the registered user submitted the information of the express delivery item, the delivery route management module 122 doesn't process the delivery route to avoid disclosing of the information.

When the receiver receives and signs the wordless express delivery item, the receiver acquires the wordless information 41 of the corresponding wordless document file 40 secured on the wordless express delivery item and the wordless identity information of the wordless identity file of the registered express delivery supplier through the wordless information management application 20 installed on a terminal. The wordless information management application 20 sends the wordless information 41 and the wordless identity information to the communication center 11 of the wordless information management platform 10. The communication center 11 sends the wordless information 41 and the wordless identity information to the wordless information processing center 12. The wordless information generation module 121 of the wordless information processing center 12 analyzes the wordless information 41 to acquire the sender information, the receiver information, the delivery route and the registered user submitted the information of the express delivery item. Then the wordless information generation module 121 sends the delivery route information to the delivery route management module 122, and sends, the receiver information and the wordless identity information to the verification module 123. The delivery route management module 122 analyzes the delivery route to acquire the status of the wordless express delivery item. If the status of the wordless express delivery item shows that the express delivery item is delivering to the receiver, the verification module 123 acquires the information of the registered user from the wordless information management application 20 through the communication center 11. If the information of the registered user is the same to the receiver, the verification module 123 verifies the receiver information in the delivery route to the identity of the wordless identity information. If the receiver information in the delivery and the wordless identity information are the same, the wordless information management application 20 updates the delivery route information and stores the delivery route information in the information storage center 13. The delivery of the wordless express delivery item is complete.

It is worth mentioning that the wordless document file 40 can be preset. The preset wordless document file 40 is associated with the wordless information 41 of the express delivery item when receiving the express delivery item. Then the preset wordless document file 40 is secured on the express delivery item to form a wordless express delivery item. The preset wordless document file 40 can be preset an identification information. It is worth mentioning that the identification information can comprise the information of the express delivery supplier. The wordless information management application 20 acquires information of the express delivery item input by the sender through the wordless information management application installed on the terminal. Then the information of express delivery item is sent to the wordless information management platform 10. The wordless information management platform 10 generates the wordless information 41 according to the information of the express delivery item, and sent the wordless information 41 to the wordless information management application 20. In receiving the express delivery item, the express delivery supplier acquires the identification information from the preset wordless document file 40 via the information acquisition device 31 of the wordless information management terminal 30, and acquires the wordless information 41 from the wordless information management application 20 used by the sender. Then the information acquisition device 31 of the wordless information management terminal 30 sends the identification information and the wordless information 41 to the communication center 11 of the wordless information management platform 10. The communication center 11 sends the identification information and the wordless information 41 to the wordless information processing center 12. The wordless information processing center 12 associates the identification information with the wordless information 41.

The receiving process of the wordless express delivery item is complete. The sender is capable of inquiring the status of the wordless express delivery item through the identification information of the wordless document file 40 or the wordless information 41 of the wordless document file 40. The process of inquiring the status of the corresponding wordless express delivery item through the wordless information 41 as above description. The following introduces the process of inquiring the status of the wordless express delivery item through the identification information. The information collection module 21 of the wordless information management application program 20 acquires the identification information. The wordless information management application program 20 sends the identification information to the communication center 11 of the wordless information management platform 10. The communication center 11 sends the identification information to the wordless information processing center 12. The verification module 123 of the wordless information processing center 12 acquires the identification information. The verification module 123 identifies the identification information to acquire the wordless information 41 corresponding to the identification information. Then the verification module 123 sends the wordless information 41 to the wordless information generation module 121. The wordless information generation module 121 analyzes the wordless information 41 to acquire the sender information, the receiver information, and the delivery route information. Then the wordless information generation module 121 sends the delivery route information to the delivery route management module 122. The delivery route management module 122 analyzes the delivery route information to acquire the delivery status of the wordless express delivery item. The delivery route management module 122 sends the delivery status of the wordless express delivery item to the information collection module 21 of the wordless information management application 20 via the communication module 11. The information collection module 21 sends the delivery status of the wordless express delivery item to the information output module 22. The information output module 22 utilizes the display device of the terminal to show the delivery status of the wordless express delivery item. It is worth mentioning that the verification module 123 acquires the information of the registered user of the wordless information management application program 20 via the communication module 11. Then the verification module 123 compares the information of the registered user with the sender information. If the information of the registered user and the sender information are the same, the status of the wordless express delivery item is sent to the wordless information management application 20. If the information of the registered user doesn't match the sender information, the verification module 123 compares the information of the register with the receiver information. If the information of the registered user and the receiver information are the same, the delivery status of the wordless express delivery item is sent to the wordless information management application 20. If the information of the registered user doesn't match the receiver information, the delivery status of the wordless express delivery item doesn't be sent to the wordless information management application 20 for avoiding disclosing of information.

It is worth mentioning that the transport hub also provides receiving serves. When the provider of the express delivery item arrives at the transport hub, the provider of the express delivery item provides corresponding wordless identity file. The information acquisition device 31 of the wordless information management terminal 30 of the transport hub acquires the wordless identity information of the wordless identity file. Then the wordless identity information is sent to the wordless information management platform 10. The wordless information management platform 10 verifies the provider of the express delivery item whether is the registered user of the wordless information management platform 10. If the wordless information management platform 10 confirms that the provider of the express delivery item is the registered user of the wordless information management platform 10, the wordless information management platform 10 generates a service information and sends the service information to the wordless information management application 20 installed on the terminal of the provider of the express delivery item. The provider of the express delivery item goes to the service point of the transport hub to receive the express delivery item according to the service information. The service point of the transport hub has the wordless information management terminal 30. The wordless information management terminal 30 acquires the service information and sends the service information to the wordless information management platform 10. The wordless information processing center 12 of the wordless information management platform 10 acquires the service information via the communication center 11. If the provider of the express delivery item has provided the information of the express delivery item in the wordless information management platform 10, the wordless information processing center 12 acquires the information of the express delivery item from the information storage center 13. Then the wordless information processing center 12 sends information of the express delivery item to the wordless information management terminal 30 via the communication 11. The information output device 32 of the wordless information management terminal 30 acquires the information of the express delivery item via the information collection module 31, and displays the information of the express delivery item to exam by the provider of the express delivery item. After the provider of the express delivery item has confirmed the information of the express delivery item, the wordless information management platform 10 processes the information of the express delivery item to generate the corresponding wordless information. Then the wordless information management platform 10 sends the corresponding wordless information to the wordless information management terminal 30. The wordless information management terminal 30 sets the corresponding wordless information on a carrier 42 to form the corresponding wordless document file 40. Finally, the wordless document file 40 is secured on the corresponding express delivery item to form the wordless express delivery item. If the provider of the express delivery item has not provide the corresponding wordless information on the wordless information management platform 10, the corresponding wordless information can be provided by the wordless information management terminal 30 or the wordless information management application 20 installed on the terminal of the provider of the express delivery item.

A wordless express method of the present invention, comprising the steps of:

(A) providing an express delivery item;

(B) acquiring an express delivery item i corresponding to the express delivery item;

(C) forming a wordless document file corresponding to the express delivery item, according to the express delivery item information; and

(D) securely affixing the wordless document file to the express delivery item to form a wordless express delivery item.

The wordless express method recited above, wherein the step (C) further comprises the steps of:

(C.1) analyzing the express delivery item information to acquire a sender information, a receiver information and an express delivery item information;

(C.2) generating a delivery route information according to the sender information, the receiver information and the express delivery item information;

(C.3) process the delivery route information, the sender information, the receiver information and the express delivery item information to generating a wordless information; and

(C.4) forming a wordless document file corresponding to the express delivery item by setting the wordless information on a carrier.

After the step (C.4), the wordless express method further comprises a step (C.5): storing the wordless information to the information storage center.

In the step (C.3), the processing is coding and encrypting the delivery route information, the sender information, the receiver information and the express delivery item information.

Preferably, the wordless information is identification code. Preferably the identification code is two-dimension code.

The carrier is selected from paper, paper with a spliced surface, NFC device, RFID device and the express delivery item itself. The wordless information is set on the carrier by means selected from printing, carving and storing. The carrier is securely affixed on the express delivery item by means selected from splicing, packing and bonding.

It is worth mentioning that the step (C) is replaceable into following step (3): associate the express delivery item information with a prefabricated wordless document file according to the acquired express delivery item information, wherein the wordless document file has an identifying information to distinguish with other prefabricated wordless document file.

The step (C) further comprises:

(3.1) analyzing the express delivery item information to acquire the sender information, the receiver information and the express delivery item information;

(3.2) generating a delivery route information according to the sender information, the receiver information and the express delivery item information;

(3.3) processing the delivery route information, the sender information, the receiver information and the express delivery item information to generate a wordless information;

(3.4) acquiring the identifying information of the prefabricated wordless document file;

(3.5) associating the wordless information with the identifying information for inquiring the wordless information by the identifying information; and

(3.6) storing the wordless information and the corresponding identifying information in the information storage center.

Preferably, the identifying information is identification code. Preferably, the identifying information is two-dimension code.

The identifying information of the prefabricated wordless document file is set on a carrier. The carrier is selected from paper, paper with a spliced surface, NFC device, RFID device and the express delivery item express delivery item itself. The wordless information is set on the carrier by means selected from printing, carving and storing.

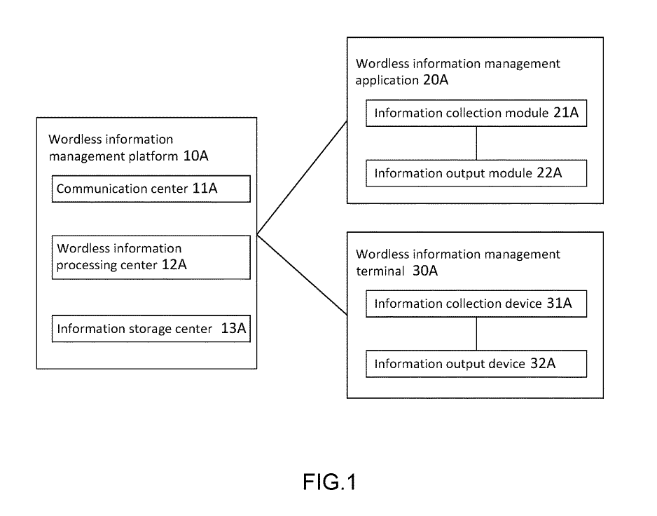

FIG. 1 is a block diagram of the wordless express delivery system according to another preferred embodiment of the present invention. The wordless express delivery system comprises a wordless information management platform 10A and at least one wordless information management terminal 30A. The wordless information management platform 10A is communicatively connected with the wordless information management terminal 30A through the communication network, for the wordless information management platform 10A communicating with the wordless information management terminal 30A. The wordless information management platform 10A processes the data sent from the wordless information management terminal 30A, and sends the result back to the wordless information management terminal 30A. The wordless information management terminal 30A can acquire the preset identification information from a prefabricated wordless document file 40A. Each of the prefabricated wordless document file 40A has the unique identification information to distinguish each of the prefabricated wordless document file 40A. The wordless information management terminal 30A can acquire the express delivery item information corresponding to the express delivery item. Then the wordless information management terminal 30A sends the acquired preset identification information and the express delivery item information to the wordless information management platform 10A. The wordless information management platform 10A processes the preset identification information and t the express delivery item information and sends the result back to the wordless information management terminal 30A. The wordless information management terminal 30A can show the result for checking the result by the sender and the receiver. It is worth mentioning that there are no words/texts on the preset identification information to record the identification information.

As shown in FIG. 1, the wordless information management platform 10A further comprises a communication center 11A, a wordless information processing center 12A and a information storage center 13A. The communication center 11A is connected with the wordless information processing center 12A. The wordless information processing center 12A is connected with the information storage center 13A. The communication center 11A is communicated with the wordless information management terminal 30A for transferring data to the wordless information management terminal 30A. The wordless information management terminal 30A sends the preset identification information and the express delivery item information to the communication center 11A of the wordless information management platform 10A. The communication center 11A sends the preset identification information and the express delivery item information to the wordless information processing center 12A. The wordless information processing center 12A acquires an express delivery supplier data from the information storage center 13A according the preset identification information. Then the wordless information processing center 12A processes the express delivery item information and the express delivery supplier data to generate a delivery route data. The delivery route data records the delivery route of the express delivery item and the current position of the express delivery item. In other words, the delivery route data records the delivery status of the express delivery item. The wordless information processing center 12A encodes to the delivery route data and associates with the preset data for inquiring the status of the express delivery item through the preset data. The wordless information processing center 12A sends the delivery route data the information storage center 13A for storage. The wordless document file 40A is securely affixed on the express delivery item to form a wordless express deliver item 50A. The preset information of the wordless document file 40A set on the wordless express deliver item 50A is acquired through the wordless information management terminal 30A to acquire the status of the wordless express deliver item 50A. It is worth mentioning that if there is no the wordless information management terminal 30A, the preset information of the prefabricated wordless document file 40A set on the wordless express deliver item 50A can not be acquired. In other words, the preset information of prefabricated the wordless document file 40 cannot acquire through reading, so as to avoid disclosing the information of the express delivery item, and protect the receiver information and/or the sender information. It is worth mentioning that the wordless information management terminal 30A needs to decode the preset identification information before the wordless information management terminal 30A sends the preset identification information to the communication center 11A of the wordless information management platform 10A.

The wordless information management terminal 30A further comprises at least an information acquisition device 31A and an information output device 32A. The information acquisition device 31A is connected with the information output device 32A. The information acquisition device 31A of the wordless information management terminal 30A provides to acquire the express delivery item information. The acquired information of the express delivery item can be shown via the information output device 32A to confirm and check the information of the express delivery item. In other words, the information acquisition device 31A provides to input the information of the express delivery item. Then the information of the express delivery item is shown through the information output device 32A so as to confirm and check the information of the express delivery item. The information acquisition device 31A can acquire the preset identification information of the prefabricated wordless document file 40A. The information acquisition device 31A acquires the information of the express delivery item and the preset identification information of the prefabricated wordless document file 40A and sends to the wordless information management platform 10A. It is worth mentioning that before the information acquisition device 31A sends the preset identification information to the wordless information management platform 10A, there is a step to decode the preset identification information. After processed by the wordless information management platform 10A, the delivery status of the wordless express delivery item 50A can be inquired through the preset information. The delivery status of the wordless express delivery item 50A can be displayed through the information output device 32A.

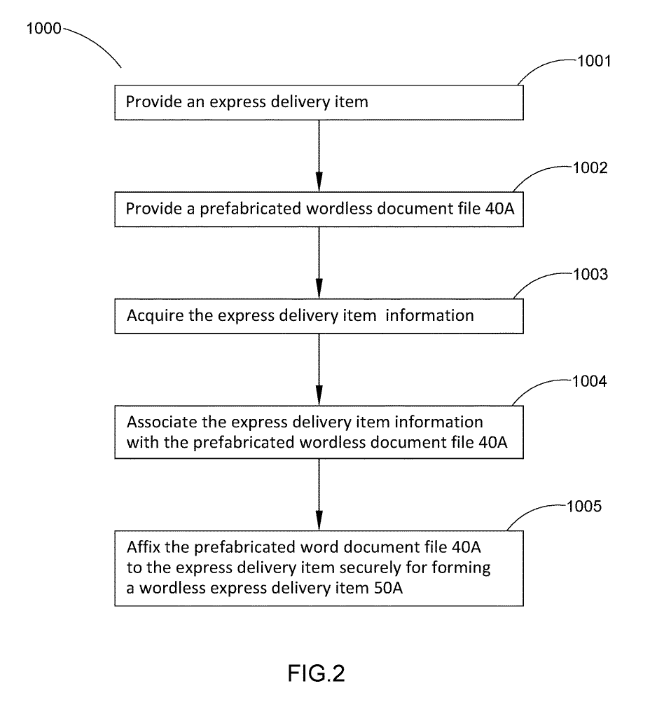

FIG. 2 illustrates a method 1000 of forming the wordless express delivery item according to a preferred embodiment of the world express delivery system of the present invention. The method of forming the wordless express deliver item 50A comprises the steps of:

Step 1001: Providing an express delivery item. The express delivery item can be received form the sender by the courier of the express delivery supplier, or sender delivers the express delivery item to the express delivery supplier. In other words, when receiving the express delivery item, the courier of the express delivery supplier is capable of receiving the express delivery item from the sender, or the sender delivers the express delivery item to the express delivery supplier. Step 1002: providing a prefabricated wordless document file 40A. The prefabricated wordless document file 40A is provided by the express delivery supplier. The prefabricated wordless document file 40A has a preset identification information. Preferably, the preset information contains the information of the express delivery supplier. Step 1003: acquiring the information of the express delivery item. The sender can input the relevant information of the express delivery item via the wordless information management terminal 30A. Step 1004: associating the information of the express delivery item with the prefabricated wordless document file 40A. The information acquisition device 31A of the wordless information management terminal 30A acquires the preset identification information of the wordless document file 40A. The preset identification information of the wordless document file 40A can not be acquired by reading the surface of the wordless document file 40A. The information acquisition device 31A of the wordless information management terminal 30A acquires the information of the express delivery item and the preset identification information of the prefabricated wordless document file 40A and the information of the express delivery item send to the communication center 11A of the wordless information management platform 10A. The communication center 11A sends the preset identification information and the information of the express delivery item to the wordless information processing center 12A. The wordless information processing center 12A acquires an express delivery supplier data from the information storage center 13A according the preset identification information. Then the wordless information processing center 12A processes the information of the express delivery item and the express delivery supplier data to generate a delivery route data and an express delivery item information data. The delivery route data records the delivery route of the express delivery item and the current position of the express delivery item. In other words, the delivery route data records the delivery status of the express delivery item. The wordless information processing center 12A separately encodes to the delivery route data and the information of the express delivery item, and associates to the coded the delivery route data with the preset identification information to inquire the status of the express delivery item via the preset identification information. By setting the preset data to inquire the status of the express delivery item, the information of the express delivery item is connected to the wordless document file 40A. The wordless information processing center 12A sends the coded delivery route data and the coded information of the express delivery item to store in the information storage center 13A. Step 1005: is to affix the prefabricated wordless document file 40A to the express delivery item securely for forming a wordless express delivery item 50A. By affixing the prefabricate wordless document file 40A to the express delivery item securely for forming a wordless express delivery item 50A. The means of affixing the prefabricate wordless document file 40A securely on the express delivery item comprises but not limited to splicing, printing, sewing and so on. It is worth mentioning that the prefabricate wordless document file 40A is capable of being manufacture together. In other words, the prefabricate wordless document file 40A is affixed on the cover material in advance. As using the cover material to cover the express delivery item to form a 50A, the prefabricate wordless document file 40A is affixed securely on the express delivery item already and the prefabricate wordless document file 40A is delivered with the wordless express delivery item 50A.

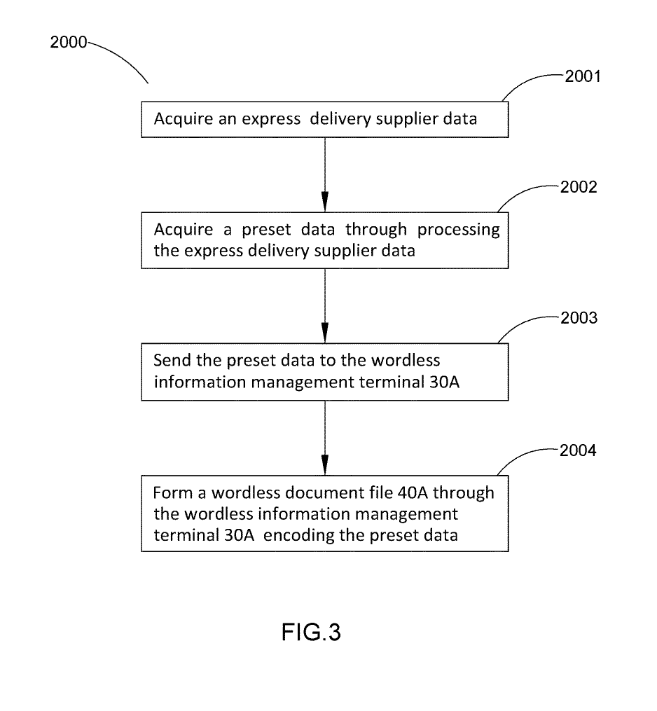

FIG. 3 illustrates a method 2000 of forming a prefabricate wordless document file 40A according to above preferred embodiment of the wordless express delivery system of the present invention. The method 2000 of forming the prefabricate wordless document file 40A, comprises the steps of:

Step 2001: Acquiring a preset data. The preset data is acquired form the information storage center 13A through the wordless information processing center 12A of the wordless information management platform 10A, or acquired by the wordless information management terminal 30A and sent to the communication center 11A of the wordless information management platform 10A. Then the communication center 11A sends the preset data to the wordless information processing center 12A. Preferably, the preset data has an information of the express delivery supplier. Step 2002: Acquiring a preset identification information by processing the preset data. The wordless information processing center 12A processes to the preset data to acquire a preset identification information for distinguish each of the wordless document file 40A. The wordless information processing center 12A encodes the preset identification information and sends the coded preset identification information to the communication center 11A. Step 2003: Sending the coded preset identification information to wordless information management terminal 30A. The communication center 11A sends the coded preset identification information to the information acquisition device 31A of the wordless information management terminal 30A. Step 2004: Encoding the coded preset identification information by the wordless information management terminal 30A for forming a wordless document file 40A. The information acquisition device 31A of the wordless information management terminal 30A encodes the coded preset identification information. Then the information acquisition device 31A sends the coded preset identification information to the information output device 32A. The information output device 32A forms a wordless document file 40A. The wordless document file 40A has a preset identification information which is encoded.

The delivery status of the wordless express deliver item 50A can be inquired via the wordless document file 40A set on the 50A. The information acquisition device 31A of the wordless information management terminal 30A acquires the preset identification information of the wordless document file 40A affixed securely on the wordless express delivery item 50A. During acquiring the preset identification information of the wordless document file 40A, the information acquisition device 31A of the wordless information management terminal 30A identifies the wordless document file 40A and decodes the wordless document file 40A to acquire the preset identification information. The information acquisition device 31A sends the preset identification information to the communication center 11A of the wordless information management platform 10A. The communication center 11A sends the preset identification information to the wordless information processing center 12A. The wordless information processing center 12A acquires the corresponding coded delivery route data and corresponding express delivery item information data according to the decodes preset identification information. The wordless information processing center 12A acquires the delivery route data of the wordless express delivery item 50A through decoding the coded delivery data. The wordless information processing center 12A acquires the express delivery item information data through decoding coded the express delivery item information data. The wordless information processing center 12A processes the delivery route data and the express delivery item information data, and generates a inquiry result and a inquiry result entrance data. The wordless information processing center 12A sends the inquiry result entrance data to the communication center 11. The communication center 11 sends the inquiry result entrance data to the information acquisition device 31A of the wordless information management terminal 30A. The information acquisition device 31A accesses the inquiry result by the inquiry result entrance data and displays the inquiry result on the information output device 32A, so that the delivery status of the wordless express delivery item 50A. During inquiring the delivery status of the wordless express delivery item 50A, the preset identification information of the wordless document file 40A affixed securely on the wordless express delivery item 50A is need to be acquired through the wordless information management terminal 30A. The delivery status of the wordless express delivery item 50A is displayed on the wordless information management terminal 30A through the information output device 32A. Comparing telephone inquiry and web inquiry provided by the express delivery supplier, the inquiry operation is efficient and convenient.

The wordless document file 40A affixed securely on the wordless express delivery item 50A is capable of improving the efficiency for sorting the wordless express delivery item 50A. As the wordless express delivery item 50A has arrived at a transport station of the express delivery supplier. The preset identification information of the wordless document file 40A on the wordless express delivery item 50A can be acquired via a wordless information management terminal 30A. Otherwise, the wordless information management terminal 30A acquires an express delivery state data. To be specific, the information acquisition device 31A of the wordless information management terminal 30A identifies the wordless document file 40A and decodes the wordless document file 40A to acquire the preset identification information of the wordless document file 40A. In addition, the wordless information management terminal 30A provides to input the express delivery state data. The information acquisition device 31A sends the preset identification information and the express delivery state data to the wordless information processing center 12A. The wordless information processing center 12A decodes the coded the preset identification information to acquire the preset identification information. According to the preset identification information, the wordless information processing center 12A acquires the delivery route data from the information storage center 13A. The wordless information processing center 12A delivers the corresponding wordless express delivery item 50A according to the delivery route data, and the corresponding wordless express delivery item is sorted in to the wordless express delivery item 50A with the same next destination. The wordless information processing center 12A processes the express delivery state data and the delivery route data. In other words, the wordless information processing center 12A updates the delivery route data according to the express delivery state data, so that the delivery status of the corresponding wordless express delivery item 50A is updated. The wordless information processing center 12A encodes the delivery route data and sends the coded delivery route data to store in the information storage center 13A. By utilizing the wordless express delivery item 50A, the courier of the express delivery supplier needn't to read the waybill to identifies the waybill information for sorting the wordless express delivery item 50A. The sorting efficiency is improved. And during sorting, the courier of the express delivery supplier can not acquire the information of the express delivery item of the wordless document file 40A affixed securely on the wordless express delivery 50A by reading, so as to protect and avoid disclosing the information of the express delivery item. It is worth mentioning that during updating the delivery route, the delivery status of the wordless express delivery item 50A can be displayed through the wordless information management terminal 30A for confirming and checking.

The wordless express delivery system of the present invention further comprises at least a wordless information management application 20A. The wordless information management application 20A is communicatively connected to the wordless information management platform 10A by communication network, for sending the information of an express delivery item acquired by the wordless information management application 20A and/or a preset identification information of the wordless document file 40A to wordless information management platform 10A. The wordless information management platform 10A processes the information of the express delivery item and the preset identification information, then returns the result of processing to the wordless information management application 20A. The wordless information management application 20A can display the result of processing. The wordless information management application 20A can display the information of the express delivery item input by the sender.

The wordless information management application 20A further comprises a information collection module 21A and a information output module 22A. The information collection module 21A is communicatively connected with the information output module 22A. The information output module 22A identifies and decodes the wordless document file 40A to acquire the preset identification information of the wordless document file 40A. The information collection module 21A is provided to input the information the express delivery item corresponding to the express delivery item. The information collection module 21A sends the preset identification information and the information the express delivery item to the communication center 11A of the wordless information management platform 10A. The information output module 22A is provided to display the information.

The wordless information management application 20A is installed on a terminal. The terminal needs to have an operating system to run the wordless information management application 20A. The terminal needs to have at least one input device to input the information of the express delivery item and/or the preset identification information of the wordless document file 40A. The terminal needs to have an output device. The terminal needs to have a communication device for connecting the wordless information management platform 10A by the communication network. Preferably, the terminal is an intelligent terminal. Since the wordless information management application 20A installed on the intelligent terminal, the intelligent terminal with the wordless information management application 20A is applied in the wordless express delivery system to reduce cost. In other words, the wordless express delivery system of the present invention can communicate with the wordless information management terminal 30A to process the information/data sent by the wordless information management terminal 30A, and feed back the processing result to the wordless information management terminal 30A. The wordless information management terminal 30A displays the processing result. The wordless express delivery system is capable of communicating with the terminal installed the wordless information management application 20A to process the information/data sent by the terminal installed the wordless information management application 20A, and feed back the processing result to the terminal installed the wordless information management application 20A. The terminal installed the wordless information management application 20A shows the processing result. An intelligent terminal installs the wordless information management application 20A. The information collection module 21A of the wordless information management application 20A acquires the information of the express delivery item and/or the preset identification information of the wordless document file 40A by the input device of the terminal. Then the information collection module 21A of the wordless information management application 20A sends the information of the express delivery item and/or the preset identification information to the communication center 11A of the wordless information management platform 10A by the communication device of the terminal. The information output module 22A shows the information of the express delivery item and/or the delivery status of the express delivery item by the display device of the terminal.

34 [symbol] 16 [symbol] It is worth mentioning that the preset identification information of the wordless document file 40A is an identification code. In the method 2000 of forming a the prefabricate wordless document file 40A, and in the Step 2004, the information acquisition device 31A of the information output device 32A encodes the coded preset data, then the information acquisition device 31A sends the present data that has been encoded twice to the information output device 32A. The information output device 32A generates an identification code according to the preset identification information that has been encoded twice and output the identification code. Preferably, the information output device 32A prints the identification code on a label carrier, for sticking the identification code on the express delivery item to form a wordless express delivery item 50A. It is worth mentioning that the identification code is printed on the cover material in advance. As using the cover material printed the identification code to cover the express delivery item, a wordless express delivery item 50A is formed. It is worth mentioning that if using the terminal with the wordless information management application 20A, the information collection module 21A of the wordless information management application 20A encodes the coded preset data, then the information collection module 21A sends the coded preset data to the information output device 32A. The information output device 32A generates an identification code according to the coded preset data, then displays and outputs the coded preset data via the output device on the terminal. Printing is a preferred method in output method.

Preferably, there is no words on the surface of the identification code, so as to not acquire the information of the express delivery item by reading the surface of the identification code. Preferably, the identification code is two-dimension code.

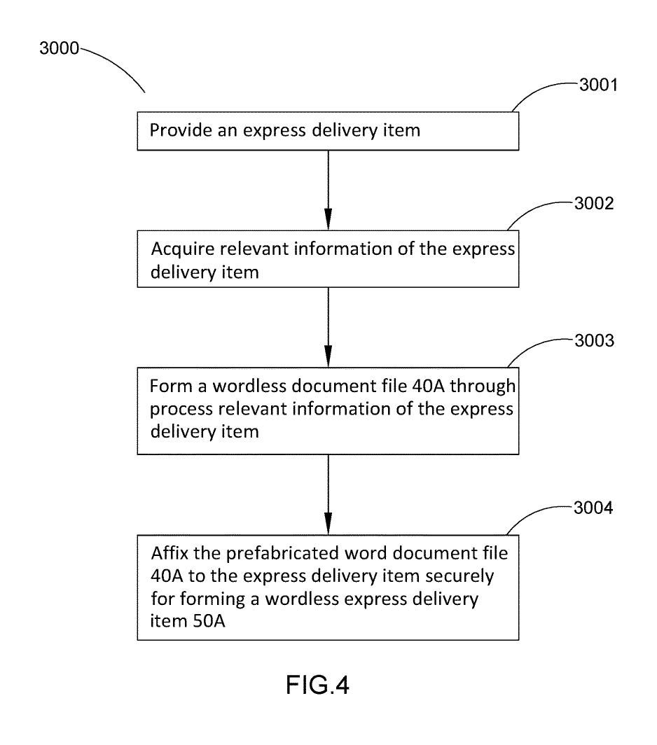

FIG. 4 is a flow diagram of a wordless express delivery system according to above preferred embodiment of the present invention illustrating a method 3000 to form a wordless document file 40A, wherein the wordless document file 40A is two-dimension code wordless document file 40A. Step 3001: provide an express delivery item. The express delivery item can be received from the position of the sender by the courier of the express delivery supplier, or the sender delivers the express delivery item to the position of the express delivery supplier. Step 3002: provide the relevant information of the express delivery item. The sender can input the relevant information of the express delivery item via the wordless information management terminal 30A or the input device of the terminal with wordless information management application 20A. The information of the express delivery item at least comprises the address of the receiver. Step 3003: generate a two-dimension code by processing relevant information of the express delivery item. The two-dimension code has the information of the express delivery item. The information of the express delivery item is sent to the communication center 11A of the wordless information management platform 10A. The communication center 11A sends the information of the express delivery item to the wordless information processing center 12A. The wordless information processing center 12A acquires an express delivery item information data from the information storage center 13A according the information of the express delivery item. The wordless information processing center 12A acquires an express delivery supplier data from the information storage center 13A according to the express delivery item information data. The wordless information processing center 12A acquires a delivery route data through processing the information of the express delivery item and the express delivery supplier information data. The wordless information processing center 12A separately encodes the delivery route data and the express delivery item information data. The wordless information processing center 12A sends the coded delivery route data to store in the information storage center 13A. The wordless information processing center 12A sends the coded the express delivery item information data to the communication center 11A. The communication center 11A sends the coded the express delivery item information data to the information acquisition device 31A of the wordless information management terminal 30A. The information acquisition device 31A of the wordless information management terminal 30A encodes the coded express delivery item information data again and sends to the information output device 32A. The information output device 32A of the wordless information management terminal 30A outputs the two-dimension code. Preferably, the information output device 32A shows and prints the two-dimension code for affixing the two-dimension code securely on the corresponding express delivery item. If using the terminal installed with the wordless information management application 20A acquires the coded express delivery item information data, the communication center 11A sends the coded express delivery item information data to the information collection module 21A of the wordless information management application 20A. The information collection module 21A encodes the coded express delivery item information data again, and sends to the information output module 22A. The information output module 22A outputs the two-dimension code. Preferably, the information output module 22A utilizes the display device of the terminal to show the two-dimension code. If the terminal connected to a print device, the information output module 22A utilizes the print device of the terminal to print the two-dimension code to set the two-dimension code on the corresponding express delivery item. Step 3004: affix the two-dimension code on the express delivery item securely for forming a wordless express delivery item 50A. Preferably, to print the two-dimension code, and affix two-dimension code securely on the express delivery item, to form a wordless express delivery item 50A. The two-dimension code has express delivery item information data. The two-dimension code can be printed on the cover material in advance. As using the cover material to cover the express delivery item, a wordless express delivery item 50A is formed.

The wordless information management application 20A is installed on a terminal. The express delivery item information input through the wordless information management application 20A is sent to the wordless information management platform 10A. The wordless information management platform 10A processes the express delivery item information and sends the processing result back to the wordless information management application 20A. The wordless information management application 20A generates a two-dimension code. When the courier of the express delivery supplier receiving the express delivery item, the express delivery item information data is acquired and displayed the wordless information management terminal 30A. After the sender confirmed the express delivery item information data, the two-dimension code is printed through the wordless express delivery management terminal 30A. And the two-dimension code is affixed securely on the corresponding express delivery item, and a wordless express delivery item is formed. Receiving the wordless express delivery item is finished. In additional, the sender is capable of affixing the two-dimension code securely on the express delivery item. After the courier of the express delivery supplier confirms with the sender regarding the express delivery item information stored in the two-dimension code, the processing of receiving the express delivery item is finished. In the entire processing of receiving the express delivery item is finished, the express delivery item information data isn't disclosed. In other words, the express delivery item information data isn't disclosed the public by using the waybill written in texts/words, so that the express delivery information data is prevented from being disclosed and the sender privacy and the receiver privacy are protected. It is worth mentioning that there is no texts/words on the surface of the wordless express delivery item and there is no texts/words on the two-dimension code. By using the receiving method as above, the sender gets rid of the limitation of the waybill, and presets the two-dimension code, so that the time of receiving the express delivery item is reduced, the express delivery information is prevented disclosing, and the sender privacy and receiver privacy are protected.

36 [symbol] 23 [symbol] The delivery status of the wordless express delivery item 50A is capable of being inquired via the two-dimension code affixed on the wordless express delivery item 50A. The information acquisition device 31A of the wordless information management terminal 30A acquires the coded express delivery information data of the two-dimension code through identifying and decoding the two-dimension code. The information acquisition device 31A sends the coded express delivery information data to the communication center 11A of the wordless information management platform 10A. The coded express delivery information data of the two-dimension code is capable of being acquired through a terminal installed the wordless information management application 20A. The information collection module 21A of the wordless information management application 20A acquires the coded express delivery information data through identifying and decoding the two-dimension code by an input device of the terminal, such as a camera. The information collection module 21A sends the coded express delivery information data to the communication center 11A of the wordless information management platform 10A. The communication center 11A sends the coded express delivery information data to the wordless information processing center 12A. The wordless information processing center 12A decodes the coded express delivery information data to acquire the express delivery information data. The wordless information processing center 12A acquires the coded delivery route data from the information storage center 13A according to the express delivery information data. The wordless information processing center 12A decodes coded delivery route data to acquire the delivery route data. The wordless information processing center 12A acquires an inquiry result and an inquiry result entrance data through processing the express delivery information data and the delivery route data. The inquiry result is capable being accessed through the inquiry result entrance data. The inquiry result entrance data is sent to the information acquisition device 31 of the wordless information management terminal 30A through the communication center 11A. The information acquisition device 31 accesses the inquiry result according to the inquiry result entrance data. Then the inquiry result is displayed through the output device of the terminal instructed by the information output module 22A. It is worth mentioning that the wordless information processing center 12A acquires an inquiry result and an inquiry result entrance data through processing the express delivery information data and the delivery route data. The inquiry result is capable of being sent to the wordless information management terminal 30A directly, so as to the inquiry result is displayed on the wordless information management terminal 30A. Or the inquiry result is sent to the terminal installed the wordless information management application 20A, and the inquiry result is displayed on the terminal directly.

The delivery status of the wordless express delivery item 50A is updated through modifying the delivery route data of the wordless express delivery item 50A. To acquire the coded the express delivery information data through identifying and decoding the two-dimension code. Then the coded express delivery information data and a express delivery state data are sent to the wordless information processing center 12A of the wordless information management platform 10A. The wordless information management center 12 decodes the coded express delivery information data to acquire the express delivery information data. The wordless information processing center 12 acquires the coded delivery route data from the information storage center 13A according to the express delivery information data. The wordless information processing center 12 decodes the coded delivery route data to acquire the delivery route data. The wordless information processing center 12 processes the delivery state data and the delivery route data. The wordless information processing center 12 modifies the delivery route data according to the delivery state data, so that the delivery status of the wordless express delivery item 50A is update. The wordless information processing center 12 encodes the modified delivery route data, and sends to store in the information storage center 13A.

It is worth mentioning that the preset identification information of the wordless document file 40A can be configured into a NFC (Near Field Communication) device 30B. The preset identification information can be stored in the NFC device 30B. The information acquisition device 31A of the wordless information management terminal 30A acquires the preset identification information, then the information acquisition device 31A of the wordless information management terminal 30A acquires an the express delivery item information. The information acquisition device 31A sends the preset identification information acquired from NFC device 30B and the express delivery item information to the wordless information management platform 10A. The wordless information management platform 10A processes the preset identification information and the express delivery item information for associating the express delivery item information with the preset identification information, so that the NFC device 30B is associated with the express delivery item information. Then NFC device 30B is affixed securely on the express delivery item corresponding to the express delivery item information to form a wordless express delivery item 50A.

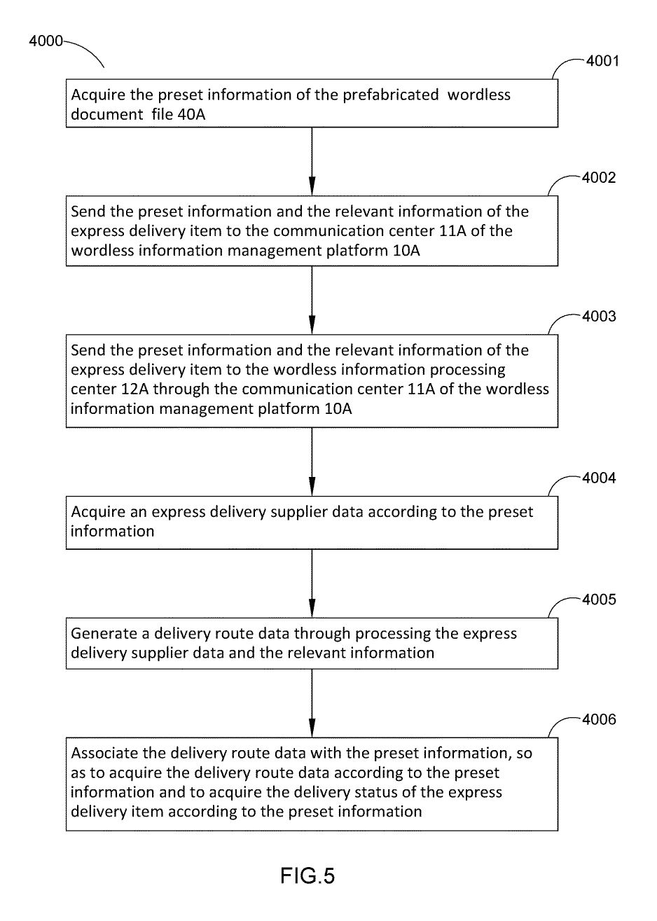

FIG. 5 is a flow diagram of a wordless express delivery system according to above preferred embodiment of the present invention illustrating a method 4000 of forming the wordless express delivery item 50A. Step 4001: provide an express delivery item. The express delivery item can be retrieved from the sender by the courier of the express delivery supplier, or delivered to the express delivery supplier by the sender. Step 4002: provide the relevant information of the express delivery item. The sender can input the relevant information of the express delivery item via the wordless information management terminal 30A or the input device of the terminal installed the wordless information management application 20A. The express delivery item information comprises the address of the receiver. Step 4003: acquire a coded express delivery information data through processing the express delivery item information. The express delivery item information is sent to the communication center 11A of the wordless information management platform 10A. The communication center 11A sends the express delivery item information to the wordless information processing center 12A of the wordless information management platform 10A. The wordless information processing center 12A acquires a express delivery item information data through processing the express delivery item information. The wordless information processing center 12A acquires an express delivery supplier data from the information storage centre 13A according to the express delivery item information data. Then the wordless information processing center 12A processes the express delivery item information data and the express delivery supplier data to generate a delivery route data. The wordless information processing center 12A separately decodes to the delivery route data and the express delivery item information data. The wordless information processing center 12A sends the coded delivery route data to store in the information storage center 13A. The wordless information processing center 12A sends the coded express delivery item information data to the communication center 11A. The communication center 11A sends the coded express delivery item information data to the information acquisition device 31A of the wordless information management terminal 30A. The information acquisition device 31A of the wordless information management terminal 30A sends the coded express delivery item information data to the NFC device 40B. If utilizing a terminal installed the wordless information management application 20A to receive the express deliver item information data, the terminal needs to be provided with the NFC module for communicating with the NFC device 40B. The information collection module 21A of the wordless information management application 20A communicates with the NFC device 40B through the NFC module of the terminal 40B. Preferably, the NFC device 40B is a NFC chip. Step: 3004: Affix the NFC device 40B securely on the corresponding express delivery item to form a wordless express delivery item 50A.

39 [symbol] 8 [symbol] It is worth mentioning that the preset identification information of the wordless document file 40A can be configured into a RFID (Radio Frequency Identification) device 30C. The preset identification information can be stored in the RFID device 30C. The RFID device 30C can be the carrier 42 of the present identification information. The information acquisition device 31A of the wordless information management terminal 30A acquires the preset identification information from the RFID device 30C. Then the information acquisition device 31A of the wordless information management terminal 30A acquires an express delivery item information. The information acquisition device 31A sends the preset identification information acquired from RFID device 30C and the express delivery item information to the wordless information management platform 10A The wordless information management platform 10A processes the preset identification information and the express delivery item information to associate the RFID device 30C and the express delivery item. Then RFID device 30C is affixed securely on the express delivery item corresponding to the express delivery item to form a wordless express delivery item 50A.

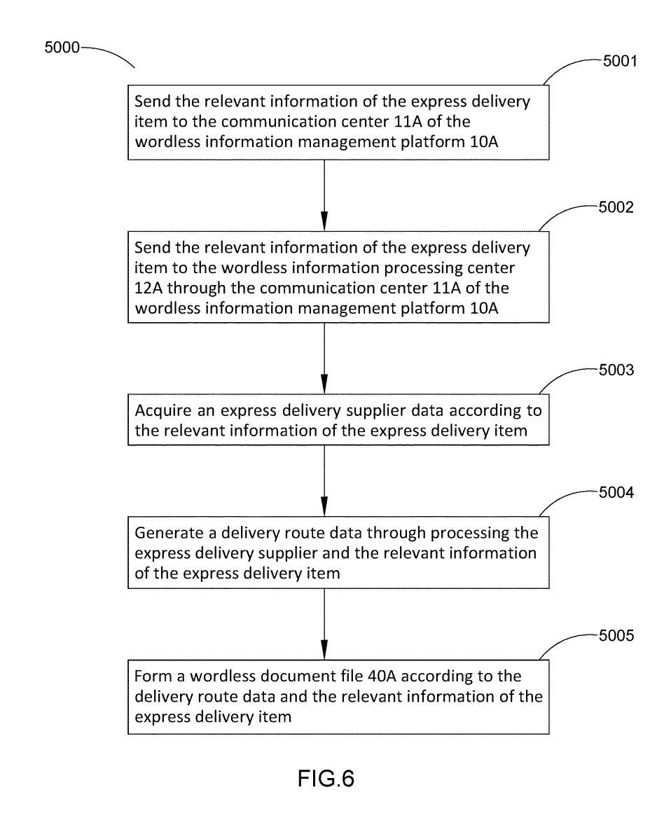

FIG. 6 is a flow diagram of a wordless express delivery system according to above preferred embodiment of the present invention illustrating a method 5000 of forming the wordless express delivery item 50A. Step 5001: provide an express delivery item. The express delivery item can be retrieved from the sender by the courier of the express delivery supplier, or delivered to the express delivery supplier by the sender. Step 5002: provide the relevant information of the express delivery item. The sender can input the relevant information of the express delivery item via the wordless information management terminal 30A or the input device of the terminal installed the wordless information management application 20A. The information of the express delivery item comprises the address of the receiver. Step 5003: acquire a coded express delivery item data through processing the express delivery item information. The express delivery item information is sent to the communication center 11A of the wordless information management platform 10A. The communication center 11A sends the express delivery item information to the wordless information processing center 12A. Then the wordless information processing center 12A processes the express delivery item information to acquire an express delivery item information data. The wordless information processing center 12A acquires an express delivery supplier data from the information storage center 13A according to the express delivery item information data. The wordless information processing center 12A processes the express delivery item information data and the express delivery supplier data to acquire a delivery route data. The wordless information processing center 12A separately encodes the delivery route data and the express delivery item information data. The wordless information processing center 12A sends the coded delivery route data to store in the information storage center 13A. The wordless information processing center 12A sends the coded express delivery item information data to the communication center 11A. The communication center 11A sends the coded express delivery item information data to the information acquisition device 31A of the wordless information management terminal 30A. The information acquisition device 31A of the wordless information management terminal 30A sends the coded express delivery item information data to store in the RFID device 30C. If utilizing a terminal installed the wordless information management application 20A to receive the coded express delivery item information data, the terminal need to have an RF reader for communicating with the RFID device 30C. The information collection module 21A of the wordless information management application 20A communicates with the RFID device 30C through the RF reader of the terminal. Through the RF reader of the terminal, the coded express delivery item information data is sent to store in the RFID device 30C. Preferably, the RFID device 30C is a RFID chip. Step 5004: Affix the RFID device 30C securely on the corresponding express delivery item to form the wordless express delivery item 50A.

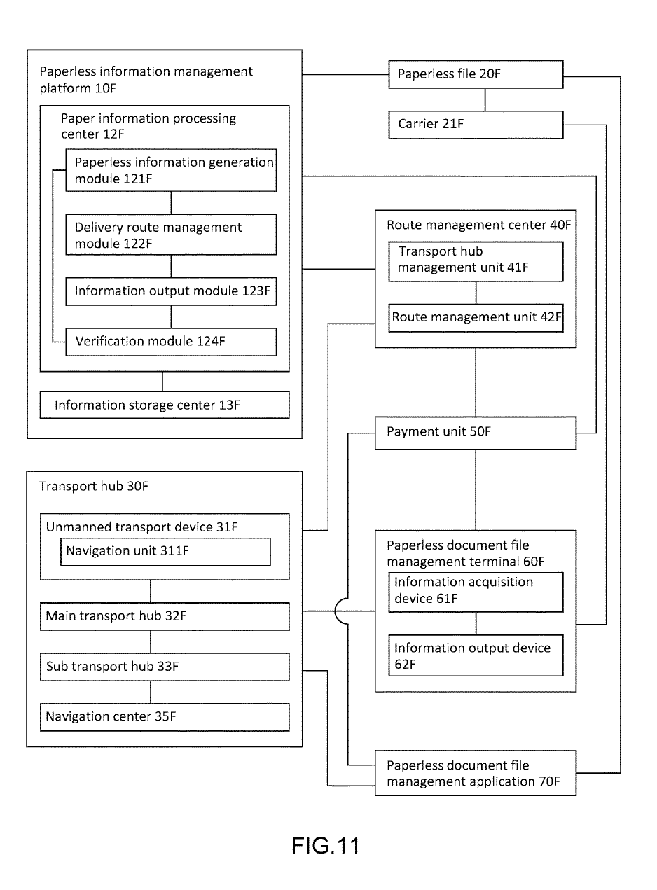

FIG. 11 is a block diagram of another preferred embodiment of a paperless express delivery system of the present invention. paperless express delivery system The paperless express delivery system of present invention comprises a paperless information management platform 10F, which forms at least one paperless document file 20F. The paperless document file 20 is conveniently to transport on the network and apply on kinds of intelligent terminal, such as the PC, laptop, table PC, smart phone and wearable device. Using the intelligent terminal can visits the paperless information management platform 10F through the network. The paperless document file 20F is recorded in the corresponding the express delivery item information, such as the sender information, the receiver information, the type of item and the number of item and so on. By the paperless document file 20F, the sender and/or the receiver can inquire the express delivery item state, such as the delivery status of express delivery item, whether been received and so on. The sender input the express delivery item information by the paperless information management platform 10F. Then the paperless information management platform 10F generates the corresponding the paperless document file 20F according to the input express delivery item information. It is worth mentioning that when the sender input the express delivery item information through the paperless information management platform 10F, if the sender has used the paperless information management platform 10F, the sender information is input automatically. If the sender uses the paperless information management platform 10F for the first time, after the sender information is finished inputting, the sender information is stored in the paperless information management platform 10F for the convenience of using the paperless information management platform 10F next time. When the sender input the express delivery item information by the paperless information management platform 10F, if the sender has used the paperless information management platform 10F, the receiver information is shown automatically for choosing. The sender chooses the corresponding receiver information. If there is not corresponding receiver information, the sender is capable of inputting the receiver information manually. The receiver information is input by the sender is stored in the paperless information management platform 10F. If the sender uses the paperless information management platform 10F at the first time, the receiver information needs to input manually. It is worth mentioning that when the corresponding receiver uses i the paperless information management platform 10F as the sender, the corresponding information of the receiver is input automatically as the sender. It is worth mentioning that the user can login and use the paperless information management platform 10F via the identity information of the user. The identity information refers to the phone number, instant messaging software account (such as QQ, wechat, Skype, Whatsaap, Line) and e-mail address and so on. It is worth mention that the paperless information management platform 10F can form the corresponding paperless document file 20F according to the sender information or the receiver information for the sender or the receiver accessing the paperless information management platform 10F.

The paperless document file platform 10F further comprises a paperless document file management unit 12F and an information storage center 13F. The paperless document file management unit 12F is communicatively connected with the information storage center 13F for storing the sender information, the receiving information, the relevant information of the express delivery item and the paperless document file 20F. The sender information, the receiving information and the relevant information of the express delivery item are input through the paperless document file management unit 12F. The paperless document file 20F is generated through the paperless document file management unit 12F. The paperless document file management unit 12F provides to input the express delivery item information, such as the sender information, the receiver information, and relevant information of the express delivery item. Wherein, the sender information includes the sender name, the sender address and the identification information of the sender. The identification information of sender is preferred to the phone number of the sender. The receiver information includes the receiver name, the receiver address and the identification information of the receiver. The identification information of the receiver is preferred to the phone number of the receiver. Then the paperless document file management unit 12F generates the paperless document file 20F according the input information. The paperless document file 20F and the input information are separately stored in information storage center 13F. The paperless document file management unit 12F sends the paperless document file 20 to the sender and the receiver.

The paperless document file management unit 12F further comprises an information collection module 1carrier 21F and a paperless document file generation module 122F. The information collection module 1carrier 21F communicatively connects with the paperless document file generation module 122F. The paperless document file generation module 122F acquires the input information from the information collection module 1carrier 21F for generating the corresponding paperless document file. carrier 21F Preferably, the paperless document file 20 is identification code. Preferably, the identification code is two-dimension code. Preferably, after the paperless document file 20 is generated, the paperless document file 20 is sent to the intelligent terminal of the sender according the sender information and the intelligent terminal of the receiver according to the receiver information. The sender and the receiver are capable of inquiring the corresponding express delivery item state according to the paperless document file. The information collection module 1carrier 21F stores the input information to the information storage center 13F. The paperless document file management unit 12F further comprises an information output module 123F which is communicatively connected with the paperless document file generation module 122F for outputing the paperless document file 20F to a carrier 21F, so that the carrier 21F is affixed securely on the corresponding express delivery item. The method of outputting the paperless document file 20F to the carrier 21F includes printing, carving, storing and so on. The carrier 21F comprises paper, RFID device and NFC device. It is worth mentioning that the paperless document file 20F is printed to the paper, and then the paper is affixed securely on the express delivery item, so that the corresponding express delivery item state is convenient to inquire through the paperless documents file 20F. The paperless document file management unit 12F further comprises a verification module 124F, which is communicatively connected with the information collection module 121F. The verification module 124F verifies the acquired paperless document file 20F through the information collection module 121F to determine the content of the paperless document file whether matches the corresponding express delivery information stored in the information storage center 13F.

The paperless express delivery system further comprises a plurality of transport hub 30F. The transport hub 30F further comprises a plurality of unmanned transportation device 31F, the unmanned transportation device 31F is used to transport the express delivery item between two the transport hubs 30F. The information collection module 121F further comprises at lease a capturing and recording device 1211F. The capturing and recording device 1211F is capable of being configured on the unmanned transportation device 31F to acquire the paperless document file affixed on the paperless document file 20F. The information collection module 121F acquires the paperless document file 20F through the capturing and recoding device 1211F. Then the paperless document file 20F is analyzed to acquire the corresponding the receiver of the express delivery item and the corresponding destination of the express delivery item. And the express delivery item is delivered to the destination through the unmanned transportation. The unmanned transportation device 31F refers to drone, driverless car, driverless ship and driverless train and so on. Preferably, the transport hub 30F is mobile transport hub, so as to the idle land is used and the land utilization ratio is improved. The transport hub 30F further comprises a main transport hub 32F and a plurality of sub transport hub 33F, so that the idle land is fully used. The position of the main transport hub 32F and the position of each sub transport hub 33F are movable, for optimizing the delivery efficiency of the express delivery item. The unmanned transport device 31F delivers the express delivery item between the main transport hub 32F and each sub transport hub 33F. The transport hub 30F further comprises a plurality of navigation center 35F. The navigation 35F communicates with each the unmanned transport device 31F, for navigating the unmanned transport device 31F delivering the express delivery item, and exchanging the information with each the unmanned transport device 31F. The unmanned transport device 31F further comprises a navigation unit 311F. The navigation unit 311F communicatively connects with each the navigation center 35F for acquiring the navigation data. The navigation unit 311F is capable of receiving other positioning data, such as GPS, Beidou navigation and positioning system. The navigation unit 311F designs the transport route according to the data of the positioning system. Particularly, the navigation unit 311F is capable of receiving the signal sent from the communication operators, and the navigation unit 311F confirms the position of the unmanned transport device 31F according to the signal sent from the communication operators for designing the transport route according to the position of the unmanned transport device.

The paperless express delivery system further comprises a route management center 40F. The route management center 40F is separately communicatively connected with the paperless document file management unit 12F, each of the transport hubs 30F, and the information storage center 13F, the information collection module 121F and each of the unmanned transportation devices 31F. The information collection module 121F provides the sender information and the receiver information to the route management center 40F. The route management center 40F designs at least a transport route according to the sender information, the receiver information and the position information of each of the transport hub 30F. Then the transport route is sent to the unmanned transport device 31F for assigning the unmanned transport device 31F to deliver the express delivery item. It is worth mentioning that, the route manage center 40F is capable of assigning the unmanned transport device 31F to retrieve the express delivery item.

The route management center 40F further comprises a transport hub management unit 41F. The route management center 40F communicatively connects with the information storage center 13F. The transport hub management unit 41F manages each of transport hub 30F. If the transport hub 30F is the mobile transport hub, the transport hub management unit 41F adjusts the position of the transport hub 30F according the idle land information of current position of the transport hub 30F. Furthermore, the transport hub management unit 41F configures the position of the main transport hub 32F and the position of each sub transport hub 33F for optimizing the efficiency of delivery the express delivery item. Particularly optimizing the efficiency of delivery the express delivery item between the main transport hub 32F and each sub transport hub 33F. The transport hub management unit 41F stores the position information of each transport hub 30F in the information storage center 13F. The position information of the main transport hub center 32F and the position information of each sub transport hub 33F are sent to store in the information storage center 13F. The transport hub management unit 41F configures the position of each navigation center 35F according to the position of each transport hub 30F, so as to each the transport hub 30F communicates with each the unmanned transport devices 31F. Furthermore, the transport hub management unit 41F configures each the position of the navigation center 35F according to each the position information of the main transport hub 32F and the position information of the sub transport hub 33F. The position information of each the navigation center 35F is stored in the information storage center 13F.

The route management center 40F further comprises a route management unit 42F. The route management unit 42F separately communicates with the transport hub management unit 41F, the information collection module 121F, the information storage module 13F and the paperless document file generation module 122F. The route management unit 42F analyzes the relevant information of the corresponding express delivery item acquired through the information collection module 121F and the position information of each transport hub 30F stored in the information storage center 13F. Then the route management unit 42F configures at least a transport route. Delivering or retrieving the express delivery item according to the transport route. Then the transport route is separately sent to the unmanned transport device 31F, the information storage center 13F and the paperless document file generation module 122F. The unmanned transport device 31F delivers the express delivery item according to the transport route or the unmanned transport device 31F retrieves the express delivery item in accordance with the transport route.

The paperless express delivery system further comprises a payment unit 50F. The sender and the receiver are capable of paying the delivery fee. The payment unit 50F is separately communicatively connected with the information collection module 121F, the information output module 123F, the route management center 40F, the paperless document file management unit 12F and the information storage center 13F. The payment unit 50F acquires the information of the corresponding express delivery item by the information collection module 121F, acquires the transport route from the route manage unit 42F of the route management center 40F, and calculates the delivery fee according to the information of the express delivery item and the transport route. The delivery fee is sent to eh intelligent terminal used by the sender through the information out module 123F. The sender pays for the delivery fee through the payment unit 50F through the intelligent terminal. It is worth mentioning that the receiver is capable of paying the delivery through the payment unit 50F on the terminal.

The paperless express delivery system further comprises a paperless document file management terminal 60F. The paperless document file management terminal 60F is separately communicatively connected with the paperless document file platform 10F, the route management center 40F and the payment unit 50F. The paperless document file management terminal 60F captures and records the corresponding paperless document file 20F affixed on the carrier 21F of the express delivery item, then the corresponding paperless document file 20F of the express delivery item is sent to the information collection module 121F of the paperless document file platform 10F. The paperless document file management terminal 60F provides the sender to input information, such as the sender information, the receiver information the relevant information of the express delivery item. Then the input information is sent to the information collection module 121 of the paperless document file platform 10F. The information collection module 121F sends the acquired information to the paperless document file generation module 122F for generating the paperless document file 20F. After the paperless document file is generated, the paperless document file 20F generation module 122F sends the paperless document file 20F to the information storage module 13F for storage and the information output module 123F. Through the information output module 123F, the paperless document file 20F is sent to the paperless documents file management terminal 60F. The paperless document file management terminal 60F displays the paperless document file 20F, and outputs the paperless document file 20F to the carrier 21F. The carrier 21F is affixed securely on the corresponding express delivery item.

The paperless document file management terminal 60F further comprises an information acquisition device 61F and an information output device 62F. The information acquisition device 61 communicatively connects with the information output device 62F. The information acquisition device 61F captures and recodes the paperless document file 20F, then sends the paperless document file 20F to the information collection module 121F. The information acquisition device 61F provides to input the information of the express delivery item, such as the sender information, the receiver information and the relevant information of the express delivery item, and sends the information of the express delivery item to the information collection module 121F. The information output device 62F communicatively connects with the information output module 123F of the paperless document file platform 10F. The information output device 62F receives and shows the paperless document file 20F sent by the information output module 123F or other information. The paperless document file management terminal 60F further comprises a detection device 63F. The detection device 63F detects the express delivery item to detect the express delivery item whether meets the requirement of the express delivery item. The detection device 63F is communicatively connected with the information acquisition device 61F. The detection device 63F detects the express delivery item to acquire the detection data of the express delivery item. Then the detection data of the express delivery item is sent to the information collection module 121F through the information acquisition device 61F. The detection data of the express delivery item is sent to the verification module 124F. The verification module 124F acquires and analyzes the corresponding paperless document file 20F acquired from the information storage module 13F. Then comparing the detection data of the express delivery item with the relevant information of the express delivery item through analyzing the corresponding paperless documents file 20F. If the detection data of the express delivery item and the relevant information of the express delivery item of the corresponding paperless document file 20F are not matching, the express delivery item is refused to receive. The verification module 124F disables the paperless document file 20F corresponding to the express delivery item. Preferablely, the detection device 63F is metal detector. The detection device 63F detects the express delivery item doesn't meet the requirement of the express delivery item, such as contraband. The detection device 63F raises the alarm. The express delivery item is refused to receive. It is worth mentioning that the information acquisition device 61F includes but not limited to the touch screen, camera, keyboard, scanner, NFC, RFID and so on. The information output device 62F includes but not limited to touch screen, display screen, projector and printer. The detection device 63F includes but not limited to metal detector, odor detector. It is worth mentioning that the paperless document file management terminal 60F is capable of being used to the transport hub 30F. A sorting device communicatively connects with the paperless document file management terminal 60F for assisting to sort the express delivery item.

FIG. 11 is a block diagram of a preferred embodiment of the paperless express delivery system of the present invention, illustrates the paperless document file management terminal 60F. The paperless document file management terminal 60F comprises a touch screen 611F, an identification device 612F, a communication device 613F and a print device 621F. The identification device 612F is preferred to a camera. The touch screen 611F provides to input information, such as the sender information, the receiving information and the relevant information of the express delivery item. The touch screen is capable of displaying the paperless document file 20F. The paperless document file 20F is captured and recoded through the identification device 612F, and sent to the information collection module 121F of the paperless document file platform 10F through the communication device 613F. The output information module 123F of the paperless document file platform 10F sends the information to the touch screen 611F through the communication device 613F for displaying on the touch screen 611F. The paperless document file 20F is sent to the print device 621F through the communication device 613F. The print device 621F prints the paperless document file 20F to the carrier 21F. The carrier 21F is preferred to the paper with an adhesive surface. The print device 621F prints the paperless document file 20F to another surface of the paper. Then utilizing the adhesive surface of the paper to stick the express delivery item, the paper with an adhesive surface is stuck to the express delivery item, so that the paperless document file 20F is affixed securely on the express delivery item.

The paperless document file management terminal 60F further comprises a NFC device 622F. The NFC device 622F is communicatively connected with the communication device 613F. The NFC device 622F acquires the paperless document file 20F via the communication device 613F. If the carrier 21F is another NFC device 622F, the NFC device 622F writes the paperless document file 20F to another NFC device 622F, so as to store the paperless document file 20F in another NFC device 622F as the carrier 21F.

The paperless document file management terminal 60F further comprises a RFID device 623F. The RFID device 623F is communicatively connected with the communication device 613F. The RFID device 623F acquires the paperless document file 20 via the communication device 613F. If the carrier 21F is another RFID device 623F, the RFID device 623F writes the paperless document file 20 to another RFID device 623F, so as to store the paperless document file 20 in another RFID device 623F as the carrier 21F.

The paperless document file management terminal 60F further comprises a keyboard 614F. The keyboard 614F communicatively connects with the communication device 613F for inputting information. The identification device 612F is capable of being a scanner. The paperless document file management terminal 60F further comprises an interaction interface 616F. The interaction interface 616F communicatively connects with the communication device 613F. It is worth mentioning that the interaction interface 616F is capable of being external connected with a sorting device for controlling the sorting device to sort the paperless express delivery item through the paperless express delivery system of the present invention.

It is worth mentioning that the paperless document file management terminal 60F can be made a portable type. The paperless document file management terminal 60F further comprises a housing 610F. The housing has an opening 6101F for acquiring the carrier 42F printed the paperless document file 20F through the print device 612F. The carrier 42F is the paper. The touch screen 611F, the keyboard 614F and the camera 612F are fixed in the housing 610F for inputting and displaying information. Preferably, the camera 612F is set on the back of the housing 610F. It is worth mentioning that the paperless document file management terminal 60F can be installed on the unmanned transport device 41F, so that the unmanned transport device 41F is used to retrieve or delivery the express delivery item. The paperless document file management terminal 60F further comprises a detection device 63F. The detection device 63F detects the express delivery item. The detection device 63F communicatively connects with the communication device 63F for sending the detection data to the information collection module 121F of the paperless document platform 10.

The paperless express delivery system of the present invention further comprises at least a paperless document file management application 70F. The paperless document file management application 70F can be installed in the intelligent terminal, so as to communicatively connect with the paperless document file platform 10F through the intelligent terminal. The intelligent terminal can connect to the Internet. The network refers to the Internet, communication network, satellite network and so on. The sender sends express delivery item, inquires the status of the express delivery item and processes other operation through accessing the paperless document file platform 10F by running the paperless document file management application 70F. The paperless document file platform 10F is capable of updating the express delivery item state information through the paperless document file management application 70F update delivery. Specifically, the paperless document file management application 70F separately communicatively connects with the information collection module 121F and the information output module through the intelligent terminal. The paperless document file 20F management application 70F captures and records the paperless document file 20F by calling the camera of the intelligent terminal, then the paperless document file 20F is transferred to the information collection module 121F of the paperless document file platform 10F. The paperless document file platform 10F sends the paperless document file 20F to the paperless document file management application 70F through the intelligent device. The paperless document file management application 70F displays the paperless document file 20F through the screen of the intelligent terminal. The paperless document file management application 70F utilizes the input device of the intelligent terminal to the sender input the relevant information of the express delivery item. The paperless document file management applications 70F collects the relevant information of the express delivery item and sends to the information collection module 121F of the paperless document file platform 10F through the intelligent terminal. The information collection module 121F sends the relevant information of the express delivery item to the paperless document file generation module 122F. The paperless document file generation module 122F generates the paperless document file 20F, and sends the paperless document file 20F to the information output module 123F. The information output module 123F sends the paperless document file 20F to the paperless document file management application 70F through the intelligent terminal. The paperless document file application 70F adjusts the display device of the intelligent terminal to display the paperless document file 20F.

When the sender uses the paperless express delivery system of the present invention, the sender accesses the paperless document file platform 10F. To access the paperless document file platform 10F includes at least three method: accessing the paperless document file platform 10F through the browser, accessing the paperless document file platform 10F through the intelligent terminal installed the paperless document file management application 70F, and accessing the paperless document file platform 10F through the paperless document file management terminal 60F.

For example, the sender and the receiver are used the intelligent phone installed the paperless document file management application 70F. After the sender accesses the paperless document file platform 10F, the sender inputs the relevant information of the express delivery item, such as the sender information, the receiver information, the type of the express delivery item, quantity of the express delivery item. The relevant information of the express delivery item is acquired by the information collection module 121F of the paperless document file platform 10F. Preferably, the sender information must have the phone number of the sender, and the receiver information must have the phone number of the receiver so as to the sender or the receiver receives the paperless document file 20. Then the relevant information of the express delivery information is sent to the paperless document file generation module 122F through the information collection module 121F. The paperless document file generation module 122F generates the corresponding paperless document file 20F. The corresponding paperless document file 20F is separately sent to the information output module 122F and the information storage module 13F. The information output module 123F sends the corresponding paperless document file 20F to the sender. Fox example, the sender account in the paperless document file platform 10F, the sender email, the sender's intelligent terminal or the sender account of the instant message software and so on. Preferably, the corresponding paperless document file 20F is sent to the intelligent terminal of the sender through the sender's phone number.

The courier can carry the paperless document file management terminal 60F to collect the express deliver item at the position of sending the express delivery item. When the courier collects the express delivery item, the courier verifies the express delivery item and recodes the attributes of the express delivery item, such as item name, quantity and color. The attributes of the express delivery item is sent to the information collection module 121F of the paperless document file management unit 12F of the paperless document file platform 10F through the paperless document file management terminal 60F. The information collection module 121F sends the attributes of the express delivery item to the paperless document file generation module 122F for generating the paperless document file 20F. After the courier finished collecting the express delivery item, the paperless document file 20F is outputted to the carrier 21F through the paperless document file management terminal 60F. Then the carrier 21 is affixed securely on the express delivery item. Preferably, the paperless document file 20F is printed the paper having an adhesive surface through the print device 621F of the paperless document file management terminal 60F. Then the paper having an adhesive surface is stock on the express delivery item for identifying the express delivery item.

The paperless document file 20F is sent to the receiver through the information output module 123F. For example, the receiver's account of the paperless document file platform 10F, the receiver's email, the receiver's intelligent terminal or the receiver's account of the instant message software and so on. Preferably, the corresponding paperless document file 20F is sent to the intelligent terminal of the receiver through the receiver's phone number. It is worth mentioning that the payment unit 50F sends the corresponding payment information of the express delivery item to the receiver. The receiver pays the delivery fee through the payment unit 50F. If the sender selects the receiver to pay the delivery fee, the payment 50F sends the corresponding payment information to the receiver through the information output module 123F. The receiver pays the delivery fee through the payment unit 50F. The receiver inquires the corresponding relevant information of the express delivery item through the paperless document file 20F.

It is worth mentioning that if the receiver refuses to receive the express delivery item, the receiver acquires the relevant information of the corresponding express delivery item through the paperless document file 20F. Then the corresponding receiver information of the express delivery item is modified through the information collection module 121F. When the corresponding receiver information is modified, the information output module 123F sends the remind message to the sender, such as “the receiver refuses to receive”. Then the information output module 123F provides the corresponding sender two operation options: deliver to the sender or modify the receiver. If the corresponding sender selects deliver to the sender, then the receiver cannot modify the receiver information. The route management unit 42F of the route management center 40 of the paperless document file platform 10F sends the courier to retrieve to the express delivery item from the receiver. If the corresponding sender selects to modify the receiver, the receiver modifies the corresponding receiver information. After the receiver finishes modifying the receiver information, the modified receiver is defined as the second receiver. The receiver sends the paperless document file 20F to the intelligent phone of the second receiver. The second receiver receives the corresponding express delivery item according to paperless document file 20F. It is worth mentioning that after the receiver finishes modifying the corresponding receiver information, the receiver cannot receive the express delivery item according to the paperless document file 20F. In other words, the paperless document file 20 is invalid to the receiver. The receiver sends the paperless document file 20F to the intelligent terminal of the second receiver for making the paperless document file 20F maintain efficiency. It is worth mentioning that the receiver is capable of accessing the paperless document file management unit 12F through the paperless document file 20F to modify the delivery time to the express delivery item.

It is worth mentioning that the second receiver accesses the corresponding relevant information. The second receiver is capable of modifying the corresponding receiver information. When the second receiver begins to modify the corresponding receiver information, the receiver receives the hint message “the receiver refuses to receive the express deliver item”. The information output module 123F provides the receiver two operation options: the receiver is the original receiver or modifying new receiver. If the receiver selects the operation option of the original receiver, then the second receiver cannot modify the receiver information. The route management unit 42F of the route management center 40F of the paperless document file platform 10F sends the courier to the position of the seconder receiver for retrieve the express delivery item. The second receiver needs to send the paperless document file 20F to the receiver, so that the receiver is capable of receiving the express deliver item. If the receiver selects the operation option of modifying new receiver, then the second receiver modify the corresponding receiver information. After the second receiver finishes modifying the corresponding receiver information, the modified receiver is defined as the third receiver. The second receiver sends the paperless document file 20F to the intelligent phone of the third receiver. The third receiver receives the corresponding express delivery item. It is worth mentioning that after the second receiver finishes modifying the corresponding receiver information, the second receiver cannot receive the express deliver item according to the paperless document file 20F. In other words, to the receiver, the paperless document file 20F is invalid. The second receiver sends the paperless document file 20F to the intelligent terminal of the third receiver. The third receiver receives the corresponding express delivery item.

In other words, the receiver must have the paperless document file 20F to receive the express delivery item. After the verification of the paperless document file 20F successes through the verification module 124F, the receiver is capable of receiving the express delivery item. During the delivering the express delivery item, the sender is capable of the receiver information, such as the receiver, the phone number of the receiver, the receiver's address. The former receiver is capable of modifying the latter receiver information. For instant, the receiver is capable of modifying the second receiver information. The second receiver is capable of modifying the third receiver information. After the receiver is changed, the former receiver needs to send the paperless document file 20F to the intelligent terminal of the latter receiver so as to verify the corresponding paperless document file 20F to receive the express delivery item. If the receiver hasn't the paperless document file 20F, the express delivery item cannot be received. It is worth mentioning that the former receiver is capable of selecting one of the methods to send the corresponding paperless document file 20F to the latter receiver according to the identification information of the latter receiver, such as the email, the instant message software, and the paperless document file platform 10F.

It is worth mentioning that after the receiver is modified, the payment unit 50F acquires the modified receiver information through the information module 121F, the transport hub information through the transport hub management unit 41F, and the delivery route information through the route management center 42F. The payment unit 50F generates the information modification feed through processing the receiver information, the transport hub information and the transport route information. The payment unit 50F sends the modified information feed to the information modifier through the information output module 123F. The information modifier refers to the person who modifies the receiver information. For example, the receiver modifies the receiver information, then the information modification fee is sent to the intelligent terminal of the receiver. The second receiver modifies the receiver information, then the information modification fee is sent to the intelligent terminal of the second receiver. Preferably, the modified receiver information will only be effective after the information modifier pays the information modification fee. The information modifier is capable of paying the information modification fee through the payment unit 50F.

It is worth mentioning that after the receiver is modified, the paperless document file platform 10F is capable of regenerating new paperless document file 20F, then the new paperless document file 20F is sent to the modified receiver. The modified receiver uses the new paperless document file 20F to verify for receiving the corresponding express delivery item. For example, the receiver modifies the corresponding receiver information to the second receiver information, and then the paperless document file generation module 122F acquires the second receiver information through the information collection module 121F for regenerating the new paperless document file 20F. The new paperless document file 20F is defined as the second paperless document file 20F. The second paperless document file 20F is sent to the intelligent terminal of the second receiver, so as to verify the second paperless document file 20F to receive the express deliver item.

It is worth mentioning that when the courier receives the express deliver item, if the express delivery item doesn't meet the delivery requirement through the verification, then the verification result is recoded through the paperless document file management terminal 60F and the express delivery item is rejected. After the express delivery item is rejected, the paperless document file 20F sent to the receiver is invalid. The paperless document file management terminal 60F is capable of being configured to the unmanned transport device 41F. The unmanned transport device 41F having the paperless document file management terminal 60F is used to retrieve and deliver the express delivery item. When the unmanned transport device 41 retrieves the express delivery item, the paperless document file is captured and recorded through the paperless document file management terminal 60F configured on the unmanned transport device 41F. More specifically, the paperless document file 20F is captured and recorded through the camera of the paperless document file management terminal 60F. Then the detection device 63F of the paperless document file management terminal 60F detects the corresponding express delivery item. If the detection result doesn't meet the delivery requirement, the express delivery item is rejected. More specifically, the detection device 63F sends the detection result to the information collection module 121F through the communication module 63F. The information collection module 121F sends the detection result to the verification module 124F. The verification module 124F separately acquires the delivery requirement and the corresponding paperless document file 20F from the information storage module 13F. The verification module 124F compares the detection result with the delivery requirement and the corresponding paperless document file 20F. If the detection result doesn't meet the delivery requirement, the express delivery item is rejected. If the detection result doesn't match the description of the express delivery item, the express delivery item is rejected. The paperless document file management terminal 60F outputs the paperless document file 20F to the carrier 21F. The carrier 21F is affixed securely on the express delivery item so as to facilitate sorting of the express delivery item and identification of the express delivery item. Preferably, the paperless document file management terminal 60F detachably configures in the unmanned transport device 31F so as to easy to use.

After finishing collecting the express delivery item, the route management unit 42 configures the collecting route for continuing to collect the express delivery item or returning to the transport hub 30F. Preferably, the transport hub 30F is mobile transport hub. To adjusting the position of the transport hub 30F for improving the delivery efficiency. Furthermore, the transport hub 30F comprises at least a main transport hub 31F and a plurality of sub transport hub 32F. Preferably, the unmanned transport device 31F transports the express delivery item between the main transport hub 31F and each sub transport hub 32F. The transport efficiency is improved. Preferably, the main transport hub 31F and each sub transport hub 32F are movable. Optimizing the position of the main transport hub 31F and the position of each sub transport hub are capable of improving the delivery efficiency. The transport hub management unit 41F optimizes the position of the main transport hub 31F and the position of each sub transport hub to improve the delivery efficiency. It is worth mentioning that each the transport hub 30F has the navigation center 35F for navigate each the unmanned transport device to arrive each the transport hub 30F. When collecting the express delivery item through the unmanned transport device 31F configured the paperless document file management terminal 60F, the receiver needs to provide the paperless document file 20F corresponding to the express delivery item. The corresponding paperless document file 20 is captured and recorded through the paperless document file management terminal 60F, and the corresponding the paperless document file 20F is verified through the verification module 124F. If the corresponding the paperless document file 20F is valid and matches the receiver information, then the receiver receives the express delivery item. Otherwise, the express delivery item is refused to deliver to the receiver.

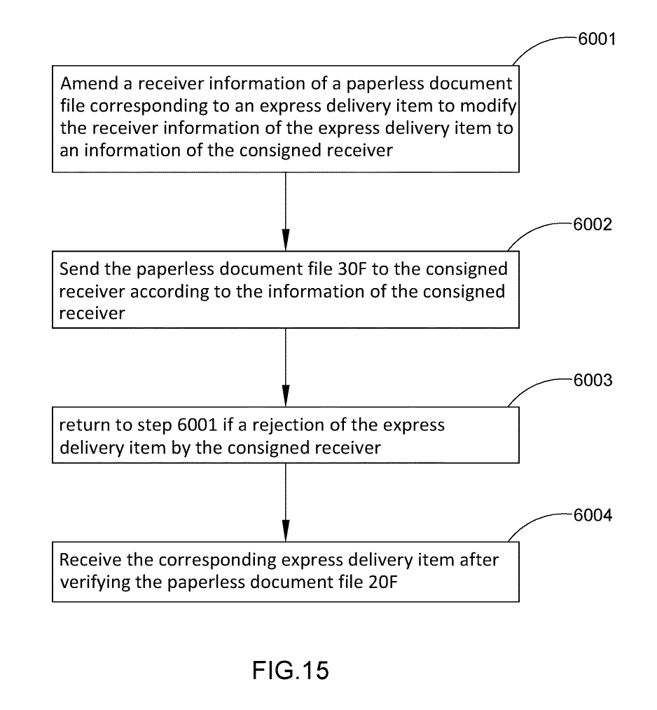

FIG. 15 is flow chat of the paperless document file system of the present invention, illustrating a consignation method of receiving the express delivery item. An entrusting method of receiving the express delivery item, comprises the steps of:

Step 6001: amend a receiver information of a paperless document file 20F corresponding to an express delivery item to modify the receiver information of the express delivery item to a consigned receiver information.

Step 6002: send the paperless document file 20F to the consigned receiver according the consigned receiver information.

Step 6003: return to the step 6001 if a rejection to receive the information of the express delivery item by the consigned receiver.

Step 6004: receive the corresponding express delivery item after verifying the paperless document file 20F.

Wherein, the Step 6001 further comprises the steps of:

Step 60011: inquire the receiver information of the corresponding express delivery item of the paperless document file 20F.

Step 60012: receive the consigned receiver information of the corresponding express delivery item of the paperless document file 20F.

Step 60013: modify the receiving information to the consigned receiver information. In other words, the consigned receiver information become a new receiver information, the consigned receiver is the new receiver.

Step 60014: store the consigned receiver information in the information storage center 13F and store the consignor information in the information storage center 13F.

It is worth mentioning that after the receiver information is modified to the consigned receiver information, the information output module 123F sends the hint message to the consigned receiver. Preferably, the information output module 123F sends the hint message to the consigned receiver instantly. To remind the consigned receiver has been consigned to receive the express delivery item corresponding to the paperless document file 20F. It is worth mentioning that the consignor edits the hint message sent to the consigned receiver through the information collection module 121F. In other words, the consignor is capable of selectively disclosing information to the consigned receiver through the information collection module 121F. The consigned receiver is capable of requesting the consignor for disclosing information through the paperless document file management application 70F. Preferably, disclosing the express delivery item information corresponding to the paperless document file 20F. After the consignor receives the request of the consigned receiver, the consignor is capable of selectively disclosing information through the information collection module 121F. In other words, during the consigning to receive the express delivery item, the consignor interacts with the consigned receiver through the information collection module 121F, the information output module 123F, the paperless document file management terminal 60F and the paperless document file management application 70F.

Wherein, the Step 6002 further comprises the step of:

Step 60021: inquire the identification information of the consigned receiver from the information of the consigned receiver;

Step 60022: send the paperless document file 20F to the consigned receiver according to the identification information of the consigned receiver; and

Step 60023: invalid the paperless document file 20F of the receiver.

The identification information refers to the phone number, the email account, and the account of instant message software, such as QQ, wechat, Skype, Whatsapp, and Line. The information output module 13F selects one of delivery method recorded in the identification information of the consigned receiver to send paperless document file 20F. After the paperless document file 20F is sent to the consigned receiver, the verification module 124F invalids the paperless document file 20F of the receiver. In other words, the receiver cannot receiver the express deliver item corresponding to the paperless document file 20F. At the same time, the receiver cannot modify the receiver information of the corresponding receiver information.

The Step 6003 further comprises the steps of:

Step 60031: receiving the information of rejection of the express delivery item sent by the consigned receiver.

Step 60032: sending the consigner operation tips: modify corresponding receiver information to the consignor information or modified receiver information.

Step 60033: if receiving the feedback of modifying corresponding receiver information to the consignor information, modifying the consignor information to the consigned receiver information, the return to the step 6001.

Step 60034: return to step 6001, if receiving the feedback of modifying the receiver information.

The corresponding express delivery item information is inquired according to the paperless document file 20F after the consigned receiver receives the paperless document file 20F. If the consigned receiver refuses to receive the corresponding express delivery item, the information collection module 121F receives the rejection information of the corresponding express delivery item. Then the information output module 123F sends the consignor the prompt message for prompting the operator that the consigned receiver refuses to receive the corresponding express delivery item, and sends the consignor the operation tips: setting the corresponding receiver information to the consignor information of the modified receiver information. If the information collection module 121F receives the feedback of setting the consignor information as the consigned receiver information, then the information collection module 121F sets the consignor information as the consigned receiver information. If the information collection module 121F receives the feedback of modifying the modified receiver information, then return to the step 6001.

In step 6004, the verification module 124F acquires the paperless document file 20F through the information collection module 121F, and acquires the consigned receiver information from the information storage center 13F. Comparing the receiver information of the express delivery item corresponding to the paperless document file 20F with the consigned receiver information. If the receiver information of the express delivery item corresponding to the paperless document file 20F matches the consigned receiver information, the consigned receiver receives the corresponding express delivery item. If the receiver information of the express delivery item corresponding to the paperless document file 20F doesn't match the consigned receiver information, the consigned receiver cannot receive the express delivery item.

It is worth mentioning that between the Step 6001 and Step 6002 further comprises a step 6001A′: pay the consigning cost.

The Step 6001A further comprises the steps of:

Step 6001A1: confirm the consigning cost of delivering the corresponding express delivery item according to the consigned receiver information.

Step 6001A2: send a payment request regarding the consigning cost to the consignor.

Step 6001A3: if the consignor have paid the consigning cost, modify corresponding receiver information to the consigned receiver information, deliver the express delivery item according to the consigned receiver information, then return to step 6002; if the consignor have not paid the consigning cost, then the receiving information corresponding to the express delivery item doesn't modify successfully, and then deliver the express delivery item according to the receiver information.

The route management center 40F designs the transport route according to the consigned receiver information. The payment unit 50F confirms the consigning coast according to the transport route, the consigned receiver information and the receiver information. If the payment unit 50F confirms the consigning cost paid by the consignor, the receiver information of the corresponding express delivery item, and delivering the express delivery item according to the consigned receiver information. In this situation, the consigned receiver is the receiver, and the consigned receiver information is the receiver information. Then executing the step 6002. If the payment unit 50F confirms the consignor doesn't pay the consigning cost, then the receiver information of the corresponding express deliver item doesn't modify successfully, delivering the express delivery item according to the receiver information.

It is worth mentioning that if the consignor is the sender, then the sender is capable of modifying the receiver information before the express deliver item is received by the receiver corresponding to the express delivery item.

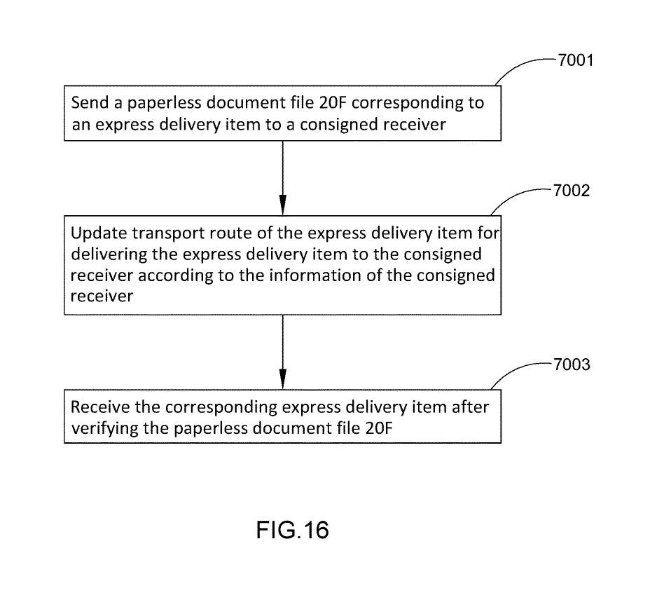

FIG. 16 is a flow chat of the paperless express delivery system of present invention, illustrating another consigning method of receiving an express delivery item. a method of consigning to receiving and express delivery item, comprises the steps of:

Step 7001: Send a paperless document file corresponding to the express delivery item to the consigned receiver;

Step 7002: Update transport route of the express delivery item for sending the express delivery item to the consigned receiver according to the consigned receiver information; and

Step 7003: Receive the corresponding express delivery item after verifying the paperless document file corresponding to the express delivery item.

Wherein the Step 7001 further comprises the steps of :

Step 70011: provide the consigned receiver information to the consignor for selecting the consigned receiver;

Step 70012: send the corresponding paperless document file to the consigned receiver according to the identification information of the selected consigned receiver. The consigned receiver information comprises the identification information of the consigned receiver. The information output module 123F acquires the identification information of the consigned receiver according to the consigned receiver information.

Step 70013: record and store the consigned receiver information in the information storage center 13F.

It is worth mentioning that after the consigned receiver receives the paperless document file, the consigned receiver sends a request to the consignor for providing the express delivery item information through the paperless document file. The consignor replies the request of the consigned receiver. The consignor selectively instantly discloses the limit information of the express delivery item to the consigned receiver through the information output module 123F. The consigned receiver instantly requests the consignor to disclose further information regarding the express delivery item through the system. According to the acquired consigning information, the consigned receiver determines whether to accept. If the consigned receiver considers the disclosed information not enough, the consigned receiver is capable of requesting the consignor to disclose more information through the paperless document file management application 70F. If the consigned receiver determines not to accept according to the disclosed consigning information, the consigned receiver rejects the consignor through the paperless management application 70F. Preferably, the information collection module 121F and the information output module 123F creates interactive window for exchanging the information between the consignor and the consigned receiver through the paperless document file management application 70F.

Between the step 7001 and step 7002 further comprises a step:

Step 7001A: If the consignor receives the corresponding paperless document file of the express delivery item, return to step 7001; if the consignor doesn't receive the corresponding paperless document file of the express delivery item, then return to step 7002.

The Step 7002 further comprises:

Step 70021: acquiring the consigned receiver information and the position information of each transport hub 30F.

Step 70022: determining the transport route of the express delivery item according to the consigned receiver information and the position information of each transport hub 30F.

Step 70023: updating the transport route of the express delivery item.

The route management unit 42F confirms the route of the transport route of the express delivery item through the consigned receiver information and the position information of the transport hub 30F. It is worth mentioning that the route management unit 42F confirms a new transport route of the express deliver item through combining each position information of each of the unmanned transport devices 31F through acquiring each of the navigation center 35F with the consigned receiver information and each position information of each transport hub 30F, so that utilizing the new transport route of the express delivery item to update. Preferably, the new transport route of the express delivery item is updated to one of the unmanned transport device 31F.

In step 7003, the verification module 124F acquires the paperless document file 20F through the information collection module 121F and the consigned receiver information from the information storage center 13F. Comparing the receiver information of the express delivery item corresponding to the paperless document file 20F with the consigned receiver information. If the receiver information of the express delivery item corresponding to the paperless document file 20F matches the consigned receiver information, the consigned receiver receives the corresponding express delivery item. If the receiver information of the express delivery item corresponding to the paperless document file 20F doesn't match the consigned receiver information, the consigned receiver cannot receive the corresponding express delivery item.

It is worth mentioning that between the step 7001A and the step 7002 further comprises a step 7001B: pay the consigning cost.

The Step 7001B further comprises the steps of:

Step 7001B1: acquire updated transport route.

The route management unit 42F confirms the updated transport route of the express delivery item through acquiring the consigned receiver information and the position information of the transport hub 30F from the transport hub management unit 41F. It is worth mentioning that the route management unit 42F confirms a updated transport route of the express deliver item through combining each position information of each of the unmanned transport devices 31F through acquiring each of the navigation center 35F with the consigned receiver information and each position information of each transport hub 30F.

Step 7001B2: confirmed the consigning cost of delivering the express delivery item according to the new transport route.

Step 7001B3: send request of paying the consigning cost to the consignor.

Step 7001B4: if the consignor pays the consigning cost, execute step 7002; if the consignor doesn't pay the consigning cost, the follow steps are not to be executed. Delivering the express delivery item to the receiver according to the original transport route.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-121. (canceled)

122. A wordless express delivery system, comprising:
at least one wordless document file, which securely affixing on an express delivery item corresponding to the wordless document file, so as to form a wordless express delivery item, wherein there is no word marking any information on said wordless document file;
a wordless information management platform, which analyzing a wordless information acquired from said wordless document file regarding to the wordless express delivery item to acquire a delivery route information, wherein the wordless express delivery item is delivered according to the delivery route information.

123. The wordless express delivery, as recited in claim 122, wherein said wordless information management platform further comprises: a communication center, a wordless information processing center and an information storage center, wherein said wordless information processing center processes the information of the express delivery item sent from said communication center and the information of the express delivery supplier acquired from said information storage center to generate the delivery route information, wherein said wordless information process center generates the wordless information through processing the information of express delivery item and the delivery route information, wherein said communication center sets the wordless information to a carrier to form said wordless document file.

124. The wordless express delivery system, as recited in claim 123, wherein said wordless information processing center further comprises:
a verification module, which verifying the identification through the wordless identification information, wherein said verification module analyzes the information of the express delivery item sent from said communication center to acquire the sender information and the receiver information, wherein the verification acquires the information of express delivery supplier from said information storage center, wherein said verification module generates the wordless identification of the sender, the wordless identification of the receiver, and the wordless identification of the express delivery supplier, so that the receiver or the sender verifies the identity of the express delivery supplier through the wordless identification information of the express delivery supplier.

125. The wordless express delivery system, as recited in claim 124, wherein said wordless information processing center further comprises:
a delivery route management module, which communicatively connecting to said verification module, wherein said delivery route management module acquires the information of the express delivery item from said verification module, the information of the express delivery supplier from said information storage center, wherein said delivery route management module generates the delivery route information through process the information of the express delivery item and the information of the express delivery supplier, wherein said delivery route assigns the delivering man and the delivering time according the delivery route information.

126. The wordless express delivery system, as recited in claim 125, wherein said word information processing center further comprise:
a wordless information generation module, which communicatively connecting to said delivery route management module, wherein said wordless information generation module generates said wordless information through encoding and encrypting the delivery route information acquired from said delivery route management module and the information of the express delivery item acquired from said verification module.

127. The wordless express delivery system, as recited in claim 126, wherein the wordless information is an identification code, wherein said communication center set said identification code to the carrier to form said wordless document file.

128. The wordless express delivery system, as recited in claim 127, wherein the carrier is a NFC device, wherein said communication center set said identification code to the NFC device to form said wordless document file.

129. The wordless express delivery system, as recited in claim 127, wherein the carrier is a RFID device, wherein said communication center set said identification code to the RFID device to form said wordless document file.

130. The word express delivery system, as recited in claim 127, wherein said identification code is two-dimension code, the carrier is the paper, wherein said communication center prints said two-dimension code to the paper to form the wordless document file.

131. The word express delivery system, as recited in claim 126, further comprising a wordless information management terminal, which communicatively connecting with said wordless information management platform, wherein said wordless information management terminal provides inquiring the delivery status of the express delivery item through acquiring the wordless information of said wordless document corresponding to the express delivery item.

132. The word express delivery system, as recited in claim 131, wherein said wordless information management terminal further comprises an information acquisition device and an information output device which is communicatively connected to said information acquisition device, wherein said information acquisition device acquires the wordless information from said wordless document file and sends the wordless information to the wordless information processing center to process through said communication center, wherein said information acquisition device acquires the delivery status of the express delivery item from said wordless information processing center through said communication center, and send s to said information output device for showing the delivery status of the express delivery status.

133. The word express delivery system, as recited in claim 133, wherein said wordless information management terminal further comprises a touch screen, a identification device and a communication device, wherein said separately communication device is communicatively connected with said touch screen and said identification device, wherein said identification device acquires the wordless information of said wordless document file and sent to said wordless information management platform through said communication device for processing the wordless information of said wordless document file, wherein said communication device acquires the delivery information of the express delivery item from said wordless information management platform and sends to said touchscreen for displaying the delivery information of the express delivery item.

134. The wordless express delivery system, as recited in claim 133, wherein said wordless information management terminal further comprises a print device, which communicatively connecting with said communication device, wherein said print device prints the wordless information acquired from said wordless information management platform through said communication device to the carrier for forming said wordless document file.

135. The wordless express delivery system, as recited in claim 133, wherein said wordless information management terminal further comprises a print device, which communicatively connecting with said communication device, wherein said print device prints the wordless information acquired from said wordless information management platform through said communication device to the carrier for forming said wordless document file.

136. The wordless express delivery system, as recited in claim 133, wherein said wordless information management terminal further comprises a NFC device, which communicatively connecting with said communication device, wherein said NFC device configures the wordless information acquired from said wordless information management platform through said communication device to another NFC device as the carrier for forming said wordless document file.

137. The wordless express delivery system, as recited in claim 133, wherein said wordless information management terminal further comprises a RFID device, which communicatively connecting with said communication device, wherein said RFID device set the wordless information acquired from said wordless information management platform through said communication device to another RFID device as the carrier for forming said wordless document file.

138. The wordless express delivery system, as recited in claim 133, wherein said wordless information management terminal further comprises a interaction interface, which communicatively connecting with said communication device, wherein said interaction interface externally connects to a sorting device for controlling the sorting device.

139. The wordless express delivery system, as recited in claim 132, wherein said information output device displays the delivery information of the express delivery item after verifying the identification information of the express delivery supplier and the wordless information of the wordless document file to the wordless information.

140. The wordless express delivery system, as recited in claim 131, further comprising a wordless information management application, which communicatively connecting to said wordless information management platform, wherein said wordless information management application is installed on an intelligent terminal for inquiring the delivery status of the express delivery item through said wordless document file.

141. The wordless express delivery system, as recited in claim 139, wherein said wordless information management application further comprises an information acquisition module and an information output module, wherein said information acquisition module is communicatively connected to said information output module, wherein said wordless information management platform sends the delivery status of the express delivery item to said information acquisition module after processing the wordless information of said wordless document file, wherein said information output module shows the delivery status of the express delivery item through the intelligent terminal.
